(19) United States
(12) Patent Application Publication
(10) Pub. No.: US 2025/0178339 A1
(43) Pub. Date: Jun. 5, 2025

(54) LIQUID DISCHARGE APPARATUS AND IMAGE FORMING APPARATUS

(71) Applicant: Akihiro Shima, KANAGAWA (JP)

(72) Inventor: Akihiro Shima, KANAGAWA (JP)

(73) Assignee: Ricoh Company, Ltd., Tokyo (JP)

(21) Appl. No.: 18/937,469

(22) Filed: Nov. 5, 2024

(30) Foreign Application Priority Data
Nov. 30, 2023 (JP) 2023-203266
Aug. 9, 2024 (JP) 2024-134451

(51) Int. Cl. B41J 2/045; B41J 2/165; B41J 15/04

(52) U.S. Cl. CPC B41J 2/04528; B41J 2/04553; B41J 2/04563; B41J 2/04581; B41J 2/16505; B41J 15/048; B41J 2202/16

(57) ABSTRACT

A liquid discharge apparatus includes: a head having a nozzle surface having nozzles to discharge a liquid; a head temperature adjuster to adjust head temperature of the head; a temperature sensor to detect: an indoor temperature; or a nozzle surface temperature around the nozzle surface; and circuitry configured to control the head temperature adjuster to adjust the head temperature based on the indoor temperature or the nozzle surface temperature detected by the temperature sensor.

### CROSS-REFERENCE TO RELATED APPLICATIONS

This patent application is based on and claims priority pursuant to 35 U.S.C. § 119(a) to Japanese Patent Application No. 2023-203266, filed on Nov. 30, 2023, in the Japan Patent Office, and Japanese Patent Application No. 2024-134451, filed on Aug. 9, 2024, in the Japan Patent Office, the entire disclosure of which is hereby incorporated by reference herein.

### BACKGROUND

### Technical Field

The present embodiment relates to a liquid discharge apparatus and an image forming apparatus.

### Related Art

A liquid discharge apparatus includes a temperature adjustment part that adjusts a temperature of a liquid to be supplied to a supply target, a detection part that detects a temperature and humidity around the supply target, a dew point temperature deriving part that derives a dew point temperature based on the detected temperature and humidity, and a dew condensation prevention processing part that controls the temperature adjustment part to allow the temperature of the liquid to be equal to or higher than the dew point temperature to execute a dew condensation prevention measure.

### SUMMARY

According to an aspect of the present disclosure, a liquid discharge apparatus is provided that includes: a head having a nozzle surface having nozzles to discharge a liquid; a head temperature adjuster to adjust head temperature of the head; a temperature sensor to detect: an indoor temperature; or a nozzle surface temperature around the nozzle surface; and circuitry configured to control the head temperature adjuster to adjust the head temperature based on the indoor temperature or the nozzle surface temperature detected by the temperature sensor.

According to another aspect of the present disclosure, a liquid discharge apparatus is provided that includes: a head having a nozzle surface having nozzles to discharge a liquid; a head temperature adjuster to adjust a head temperature of the head; a cap to cover the nozzle surface; a temperature sensor to detect: an indoor temperature; or a nozzle surface temperature around the nozzle surface; and circuitry configured to control the head temperature adjuster to adjust the head temperature based on: the indoor temperature or the nozzle surface temperature detected by the temperature sensor; and an operation mode including: a liquid discharge mode to discharge the liquid from the head; and a moisturizing mode to cover the nozzle surface with the cap to moisturize the nozzle surface.

According to further another aspect of the present disclosure, an image forming apparatus is provided that includes: a head having a nozzle surface having nozzles to discharge a liquid onto a medium; a head temperature adjuster to adjust head temperature of the head; a temperature sensor to detect: an indoor temperature; or a nozzle surface temperature around the nozzle surface; and circuitry configured to control the head temperature adjuster to adjust the head temperature based on the indoor temperature or the nozzle surface temperature detected by the temperature sensor.

According to further another aspect of the present disclosure, an image forming apparatus is provided that includes: a head having a nozzle surface having nozzles to discharge a liquid; a head temperature adjuster to adjust a head temperature of the head; a cap to cover the nozzle surface; a temperature sensor to detect: an indoor temperature; or a nozzle surface temperature around the nozzle surface; and circuitry configured to control the head temperature adjuster to adjust the head temperature based on: the indoor temperature or the nozzle surface temperature detected by the temperature sensor; and an operation mode including: a liquid discharge mode to discharge the liquid from the head; and a moisturizing mode to cover the nozzle surface with the cap to moisturize the nozzle surface.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic view illustrating an example of a liquid discharge apparatus according to an embodiment of the present embodiment;

FIG. 2 is a perspective view illustrating an example of a liquid discharge head;

FIG. 3 is a bottom view illustrating a nozzle plate according to a first implementation example;

FIG. 4 is a schematic view illustrating the liquid discharge heads and a head temperature adjuster, and is a view illustrating a state where one of the liquid discharge heads discharges an ink;

FIG. 5 is a schematic view illustrating the liquid discharge heads, the head temperature adjuster, and a cap, and is a view illustrating a state where nozzle surfaces are covered with the cap;

FIG. 6 is a block diagram illustrating an example of a hardware configuration of the liquid discharge apparatus according to the embodiment of the present embodiment;

FIG. 7 is a functional block diagram of a controller according to the embodiment of the present embodiment;

FIG. 8 is a graph illustrating a relationship between an indoor temperature and a set temperature in the head temperature adjuster;

FIG. 9 is a flowchart illustrating an example of processing performed in the controller;

FIG. 10 is a schematic view illustrating an example of a liquid discharge system according to the embodiment of the present embodiment;

FIG. 11 is a block diagram illustrating a hardware configuration of a digital front end (DFE) according to the embodiment of the present embodiment;

FIG. 12 is a block diagram illustrating a hardware configuration of the liquid discharge apparatus according to the embodiment of the present embodiment;

FIG. 13 is a bottom view illustrating a nozzle plate according to a first modification example;

FIG. 14 is a bottom view illustrating a nozzle plate according to a second modification example;

FIG. 15 is a bottom view illustrating nozzle plates according to a third modification example; and

FIG. 16 is a bottom view illustrating nozzle plates according to a fourth modification example.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

A liquid discharge apparatus according to an embodiment of the present embodiment will now be described herein with reference to the accompanying drawings.

In the present specification and the accompanying drawings, like reference numerals designate substantially identical components, and redundant description may be omitted.

### Liquid Discharge Apparatus According to Embodiment

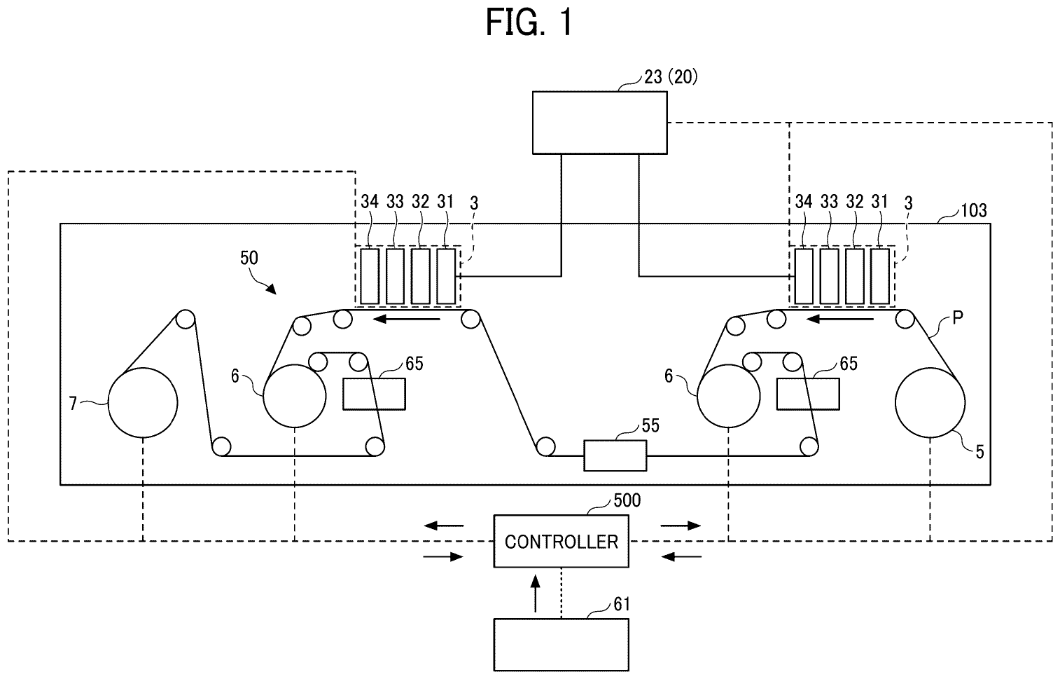

FIG. 1 is a schematic view illustrating an example of a liquid discharge apparatus 103 according to an embodiment of the present embodiment. The liquid discharge apparatus 103 may be an image forming apparatus that forms an image on a recording medium P. The liquid discharge apparatus 103 includes a controller 500, a head unit 3, an unwinder 5, a dryer 6, and a rewinder 7. The liquid discharge apparatus 103 includes a medium conveyor 50 that conveys the recording medium P. The medium conveyor 50 includes the unwinder 5 and the rewinder 7. The medium conveyor 50 may be referred to simply as a “conveyor”.

The liquid discharge apparatus 103 discharges ink droplets onto the recording medium P to form an image. The recording medium P may be a piece of paper. The recording medium P may be, for example, roll paper. The ink is an example of liquid droplets. A conveyance direction of the recording medium P extends in a longitudinal direction of the recording medium P.

The controller 500 controls entire operation of the liquid discharge apparatus 103. The unwinder 5 and the rewinder 7 are in synchronization with each other by a control signal outputted from the controller 500, and convey the recording medium P at a predetermined speed.

The head unit 3 includes a plurality of line heads 31 to 34. The line heads 31 to 34 are examples of liquid discharge heads. The liquid discharge apparatus 103 may include a plurality of the head units 3. The plurality of head units 3 includes a head unit 3 at a front stage and a head unit 3 at a rear stage. The plurality of head units 3 may respectively have configurations identical to each other. The head unit 3 at a first stage can form an image on a first surface of a recording medium P. The head unit 3 at a second stage can form an image on a second surface of the recording medium P. The first surface of a recording medium P may be a front surface. The second surface of the recording medium P may be a back surface. The phrase “front stage” refers to upstream in the conveyance direction of the recording medium P. The phrase “rear stage” refers to downstream in the conveyance direction of the recording medium P.

The unwinder 5 is disposed at a front stage of the head unit 3 at the first stage. The rewinder 7 is disposed at a rear stage of the head unit 3 at the second stage. The plurality of head units 3 is disposed between the unwinder 5 and the rewinder 7.

The medium conveyor 50 conveys a recording medium P to allow the recording medium to pass through a position immediately below the head unit 3. The line heads 31 to 34 discharge inks based on image information to apply the inks onto the recording medium P to form an image. The line head 31 discharges a black ink. The line head 32 discharges a cyan ink. The line head 33 discharges a magenta ink. The line head 34 discharges a yellow ink. There is no limitation in colors of the inks that the line heads 31 to 34 discharge.

The dryer 6 is a heating drum that conveys the recording medium P and heats the inks that the head units 3 have applied onto the recording medium P. The dryer 6 can heat the inks to allow liquid components such as moisture in the inks to evaporate, to adhere the inks onto the recording medium P, and to fix the image onto the recording medium P. The liquid discharge apparatus 103 may include a plurality of the dryers 6. The plurality of dryers 6 may be disposed at rear stages of the plurality of head units 3, respectively.

The liquid discharge apparatus 103 includes coolers 65. The coolers 65 cool the recording medium P that the dryers 6 have heated. The coolers 65 are provided at rear stages of the dryers 6, respectively. The cooler 65 at a first stage is provided at a front stage of the head unit 3 at the second stage. The cooler 65 at a second stage is provided at a front stage of the rewinder 7.

The medium conveyor 50 includes a turn bar 55. The turn bar 55 is disposed at a front stage of the head unit 3 at the second stage, and reverses the front and back surfaces of the recording medium P.

The liquid discharge apparatus 103 may include an image inspector. The image inspector reads an image fixed on a recording medium P to inspect the image. The controller 500 receives a reception signal including data of image inspection performed by the image inspector. The controller 500 can use the data of image inspection to execute various correction processing.

The liquid discharge apparatus 103 may include a pre-processor and a post-processor. The pre-processor may be disposed, for example, between the unwinder 5 and one of the head units 3. The pre-processor can perform pre-processing on a recording medium P before an image is formed. The post-processor may be disposed, for example, between one of the dryers 6 and the rewinder 7. The post-processor can perform post-processing on the recording medium P on which the image has been fixed.

The pre-processor can apply a treatment liquid onto a recording medium P, for example. The treatment liquid reacts with the inks, making it possible to suppress smearing. The post-processor may be a cooling mechanism that cools a recording medium P. The pre-processor and the post-processor may execute other processing.

### Liquid Discharge Head

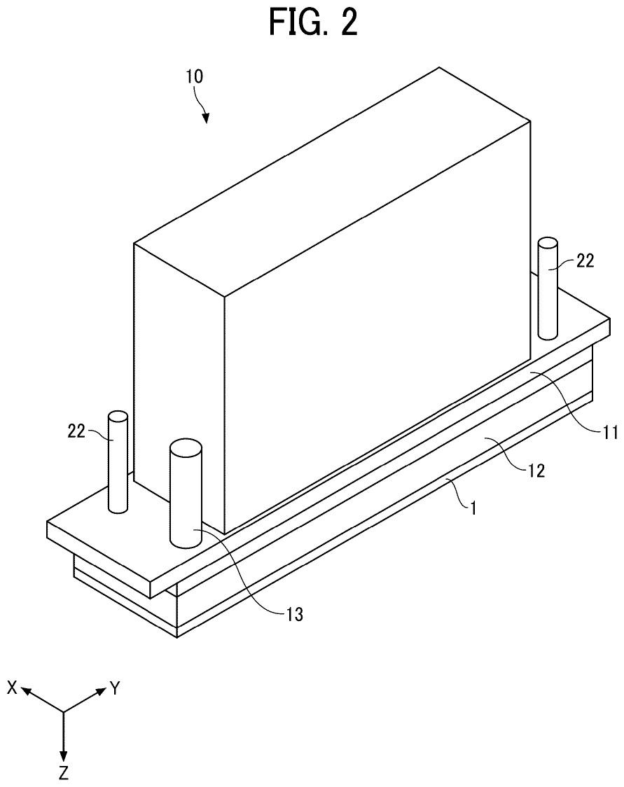

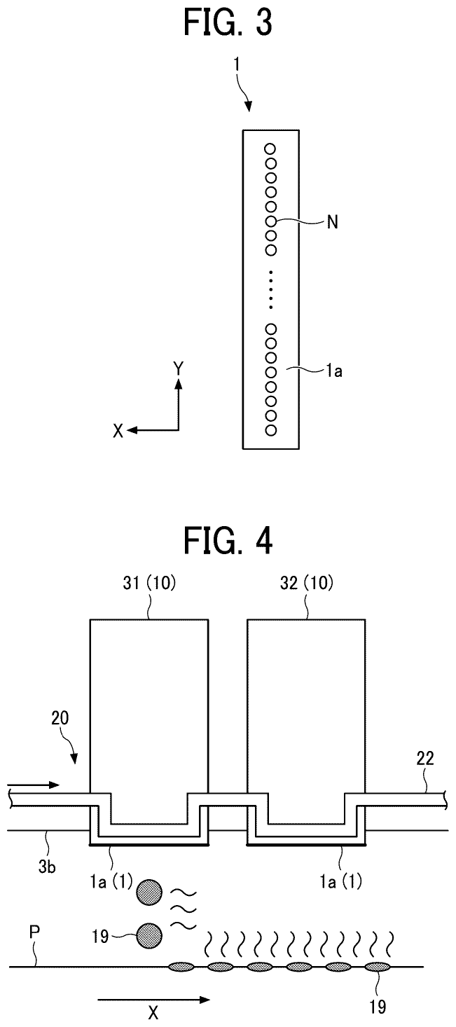

The line heads 31 to 34 each include a liquid discharge head 10. FIG. 2 is a perspective view illustrating the liquid discharge head 10. FIG. 3 is a bottom view illustrating a nozzle plate 1 according to a first implementation example. As illustrated in FIG. 2, the liquid discharge head 10 includes the nozzle plate 1, a channel member 11, a common chamber member 12, a supply port 13, and a temperature adjustment channel 22. In the channel member 11, a plurality of pressure chambers is formed. In the common chamber member 12, a common liquid chamber communicating with the plurality of pressure chambers is formed. In the channel member 11 and the common chamber member 12, a channel through which the ink flows is formed. The liquid discharge head may be referred to simply as a “head”.

The supply port 13 is in communication with the channel, the common liquid chamber, and the plurality of pressure chambers inside the liquid discharge head 10. The ink supplied into inside of the liquid discharge head 10 through the supply port 13 flows through the channel and the common liquid chamber, and is supplied to the plurality of pressure chambers.

The ink inside each of the pressure chambers is discharged from a nozzle N (see FIG. 3) formed on the nozzle plate 1.

Actuators and a control board are mounted inside the liquid discharge head 10. The actuators each include a piezoelectric element that pressurizes the ink inside each of the pressure chambers. The control board applies a drive signal (a voltage) to the actuators. The ink in each of the pressure chambers is pressurized by each of the actuators and discharged each of from the nozzles N.

The temperature adjustment channel 22 through which a temperature adjustment liquid described later flows is coupled to the liquid discharge head 10. A channel through which the temperature adjustment liquid flows is formed inside the liquid discharge head 10. The temperature adjustment liquid that has flowed inside the liquid discharge head 10 is discharged to outside of the liquid discharge head 10. The temperature adjustment channel 22 may be a circulation channel allowing the temperature adjustment liquid to circulate.

As illustrated in FIG. 3, a plurality of the nozzles N is formed on the nozzle plate 1. The nozzles N are through holes passing through the nozzle plate 1 in a plate thickness direction. The plurality of nozzles N is in communication with the plurality of pressure chambers, respectively. The nozzle plate 1 includes a nozzle surface 1a on which the plurality of nozzles N is formed. The nozzle surface 1a is a surface that faces a recording medium P. The nozzle surface 1a is a surface that is in contact with outside of the liquid discharge head 10. A nozzle array is formed on the nozzle surface 1a. The nozzle array includes the plurality of nozzles N arrayed in a Y-axis direction.

### Head temperature adjuster

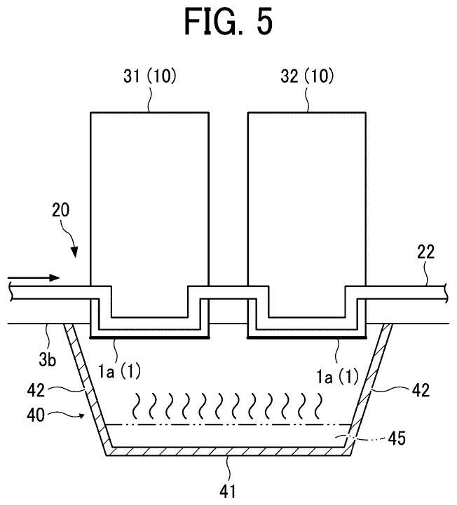

A configuration of the head temperature adjuster 20 is described below. FIG. 4 is a schematic view illustrating the liquid discharge heads 10 and the head temperature adjuster 20, and is a view illustrating a state where one of the liquid discharge heads 10 discharges an ink 19. FIG. 5 is a schematic view illustrating the liquid discharge heads 10, the head temperature adjuster 20, and a cap 40, and is a view illustrating a state where the nozzle surfaces 1a are covered with the cap 40. As illustrated in FIGS. 1, 4, and 5, the liquid discharge apparatus 103 includes the head temperature adjuster 20 that adjusts a temperature of the liquid discharge heads 10.

The head temperature adjuster 20 may heat the liquid discharge head 10 to adjust the temperature of the liquid discharge head 10, or may cool the liquid discharge head 10 to adjust the temperature of the liquid discharge head 10. The head temperature adjuster 20 allows heat to be exchanged between the liquid discharge head 10 and a fluid for temperature adjustment via the fluid for temperature adjustment, making it possible to adjust the temperature of the liquid discharge head 10. The head temperature adjuster 20 can adjust a temperature of the nozzle surface 1a of the liquid discharge head 10. The fluid for temperature adjustment may be in a form of liquid or gas. The fluid for temperature adjustment may be a refrigerant. The liquid for temperature adjustment may be referred to as a temperature-adjustment-purpose liquid.

The head temperature adjuster 20 includes the temperature adjustment channel 22. The temperature adjustment channel 22 is a channel through which the temperature-adjustment-purpose liquid flows. A tube, a pipe, a groove, or an opening, for example, is used to form the temperature adjustment channel 22. As illustrated in FIGS. 4 and 5, a part of the temperature adjustment channel 22 is formed inside the liquid discharge head 10. The temperature adjustment channel 22 may be formed to pass through a back surface side of the nozzle plate 1. A back surface of the nozzle plate 1 is a surface opposite to the nozzle surface 1a in the plate thickness direction. The temperature-adjustment-purpose liquid is a liquid different from an ink. The temperature adjustment channel 22 may be formed to pass through inside the plurality of liquid discharge heads 10. The temperature-adjustment-purpose liquid flowing inside the temperature adjustment channel 22 allows heat to be exchanged with the nozzle plate 1, making it possible to adjust the temperature of the nozzle plate 1. The head temperature adjuster 20 includes a circulation channel allowing the temperature adjustment liquid to circulate.

As illustrated in FIG. 1, the head temperature adjuster 20 includes a chiller 23 (cooler). The chiller 23 allows heat to be exchanged with the temperature-adjustment-purpose liquid to adjust the temperature of the temperature-adjustment-purpose liquid. The chiller 23 can cool the temperature-adjustment-purpose liquid.

The head temperature adjuster 20 may include, for example, a tank, a pump, a flow rate adjustment valve, and a heat exchanger, for example. The tank stores the temperature-adjustment-purpose liquid. The pump allows the temperature-adjustment-purpose liquid to move. The flow rate adjustment valve can adjust a flow rate of the temperature adjustment liquid. The heat exchanger allows heat to be exchanged with the temperature-adjustment-purpose liquid, making it possible to cool or heat the temperature-adjustment-purpose liquid.

### Cap

Next, the cap 40 will now be described herein. As illustrated in FIG. 5, the liquid discharge apparatus 103 includes the cap 40 that covers the nozzle surface 1a of the liquid discharge head 10. In FIG. 5, the cap 40 covers the nozzle surface 1a. The cap 40 forms a recess recessed downward to form a space with the nozzle surface 1a. The cap 40 includes, for example, a bottom plate 41 and a plurality of side plates 42. In a state where the cap 40 covers the nozzle surface 1a, the bottom plate 41 is disposed away from the nozzle surface 1a.

The plurality of side plates 42 is formed to surround the bottom plate 41. The plurality of side plates 42 may be disposed to be inclined with respect to upper and lower directions. Lower end portions of the plurality of side plates 42 are coupled to the bottom plate 41. Upper end portions of the plurality of side plates 42 are disposed to form an opening portion of the cap 40. In a state where the cap 40 covers the nozzle surface 1a, the upper end portions of the plurality of side plates 42 are in contact with a bottom surface 3b of the head unit 3. In a state where the cap 40 covers the nozzle surface 1a, the upper end portions of the plurality of side plates 42 are disposed to surround the nozzle surface 1a.

The cap 40 may cover the nozzle surface 1a of one liquid discharge head 10, or may collectively cover a plurality of the nozzle surfaces 1a of a plurality of the liquid discharge heads 10.

The liquid discharge apparatus 103 may include a cap opening-and-closing mechanism for opening and closing the cap 40. The cap opening-and-closing mechanism includes, for example, a hinge, a rotation shaft, an actuator, and a power transmission mechanism, for example. The actuator may be, for example, a motor or a cylinder. The power transmission mechanism may include a gear and a belt, for example. The cap opening-and-closing mechanism may move the cap 40 with respect to the nozzle surface 1a to open or close the cap 40. An opened state of the cap 40 refers to a state where the cap 40 does not cover the nozzle surface 1a. A closed state of the cap 40 refers to a state where the cap 40 covers the nozzle surface 1a. As illustrated in FIG. 5, the state where the cap 40 covers the nozzle surfaces 1a may be referred to as “during capping”.

The cap opening-and-closing mechanism may move the liquid discharge head 10 with respect to the cap 40 to allow the nozzle surface 1a to be covered with the cap 40. The cap opening-and-closing mechanism may allow the cap 40 to swing around the rotation shaft to open or close the cap 40. The cap opening-and-closing mechanism may move the cap 40 in one of the upper and lower directions to open or close the cap 40. The cap opening-and-closing mechanism moves the cap 40 relative to the nozzle surface 1a, making it possible to open or close the cap 40.

In a state where the ink 19 is to be discharged, the liquid discharge apparatus 103 sets the cap 40 to its opened state. In a state where the ink 19 is to be not discharged, the liquid discharge apparatus 103 makes the cap 40 in the closed state, making it possible to cover the nozzle surface 1a with the cap 40. In the liquid discharge apparatus 103, using the cap 40 to cover the nozzle surface 1a makes it possible to suppress drying of the ink 19 in the nozzles N.

### Wetting Liquid

The liquid discharge apparatus 103 can store a wetting liquid 45 inside the cap 40. In a state where the cap 40 covers the nozzle surface 1a, the cap 40 is filled with the wetting liquid 45. The wetting liquid 45 can wet inside the cap 40 and inside the nozzles N. The wetting liquid 45 can suppress drying inside the cap 40 and inside the nozzles N. Some of the wetting liquid 45 may evaporate inside the cap 40, making it possible to wet the nozzle surface 1a and inside the nozzles N. The wetting liquid 45 may be a desired liquid, as long as the liquid makes it possible to suppress drying of the ink inside the nozzles N.

The liquid discharge apparatus 103 may include a tank for storing the wetting liquid 45, a pipe (a channel) for transferring the wetting liquid 45, and a pump, for example. In the liquid discharge apparatus 103, the nozzle surface 1a may be covered with the cap 40 that is not filled with the wetting liquid 45.

### Hardware Configuration of Liquid Discharge Apparatus

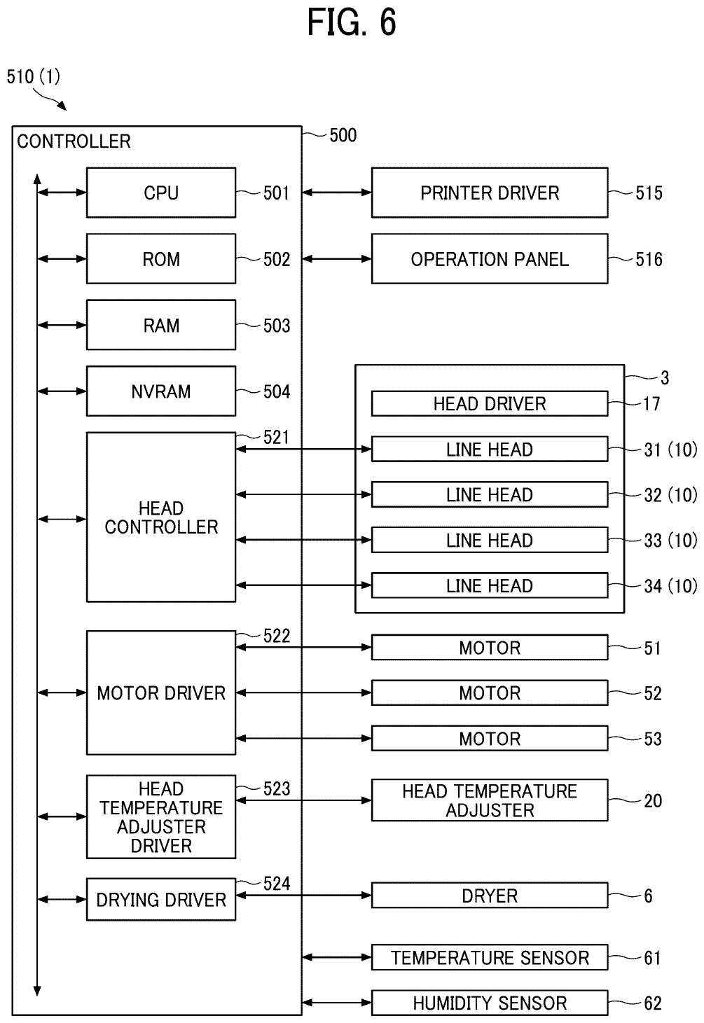

Next, a hardware configuration of the liquid discharge apparatus 103 will now be described herein. FIG. 6 is a block diagram illustrating an example of the hardware configuration of the liquid discharge apparatus 103 according to the embodiment of the present embodiment. The liquid discharge apparatus 103 includes a control device 510 including the controller 500.

A printer driver 515 is coupled to the controller 500. The printer driver 515 generates print data. The printer driver 515 may allow print data to be generated in an information processing terminal such as a personal computer (PC), an image reading device such as an image scanner, or a host device for an imaging device such as a digital camera. The printer driver 515 allows dot pattern data to be generated in the liquid discharge apparatus 103 for allowing an image to be outputted.

### Controller

The controller 500 includes a central processing unit (CPU) 501, a read only memory (ROM) 502, a random access memory (RAM) 503, and a non-volatile random access memory (NVRAM) 504.

The CPU 501 is an arithmetic operator that controls entire operation of the liquid discharge apparatus 103. The CPU 501 performs control related to conveyance operation for a recording medium P and printing operation (liquid discharge operation) using the liquid discharge head 10. The ROM 502 is a read-only non-volatile storage medium. The ROM 502 stores a program such as firmware. The RAM 503 is a volatile storage medium from and onto which it is possible to read and write information at a high speed. The RAM 503 is used as a work area when the CPU 501 processes information.

The NVRAM 504 is a non-volatile storage medium from and onto which it is possible to read and write information. The NVRAM 504 stores an operating system (OS), various control programs, and application programs, for example.

The programs stored in a storage are read into the RAM 503. The CPU 501 performs arithmetic operation in accordance with the programs loaded into the RAM 503 to configure a software controller. The storage includes the ROM 502 and the NVRAM 504. The storage may include a storage medium such as an optical disk.

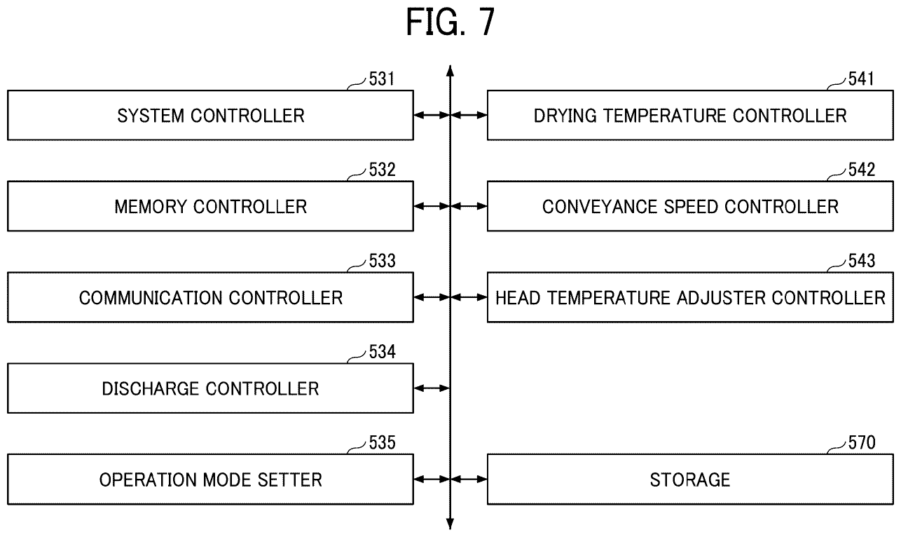

A combination of hardware and the software controller configures functional blocks implementing functions of the liquid discharge apparatus 103. The CPU 501 and the RAM 503 function as various controllers as illustrated in FIG. 7. The various controllers will be described later.

### Operation Panel

The liquid discharge apparatus 103 includes an operation panel 516. The operation panel 516 is coupled to the controller 500. The operation panel 516 represents an input portion to which a user can operate and make an input. The operation panel 516 may be, for example, a liquid crystal panel. The user can operate the operation panel 516 to change settings for printing conditions. The user can operate the operation panel 516 to change settings for various conditions.

The user can operate the operation panel 516 to input information related to a recording medium P. The user can operate the operation panel 516 to input, for example, whether or not a recording medium P is blank. Information inputted via the operation panel 516 is transmitted to the controller 500. The operation panel 516 may be a display portion and an input portion of a terminal (PC) coupled to the controller 500.

### Temperature Sensor

The liquid discharge apparatus 103 includes a temperature sensor 61. The temperature sensor 61 is electrically coupled to the controller 500. The temperature sensor 61 detects a temperature in a room in which the liquid discharge apparatus 103 is installed. The temperature sensor 61 may be installed, for example, on an outer surface of a housing of the liquid discharge apparatus 103. The temperature sensor 61 may be disposed at a position away from the housing of the liquid discharge apparatus 103. The temperature sensor 61 can detect a temperature in an environment outside the liquid discharge apparatus 103. The liquid discharge apparatus 103 may receive data related to an indoor temperature from a temperature sensor installed outside the apparatus.

The liquid discharge apparatus 103 may include a temperature sensor 61 that detects a temperature of air around the nozzle surface 1a, instead of the temperature sensor 61 that detects an indoor temperature. The temperature sensor 61 may be installed, for example, on the nozzle surface 1a. The liquid discharge apparatus 103 may include a temperature sensor 61 that detects a temperature of the nozzle surface 1a. Data of a temperature detected by the temperature sensor 61 may be data of a temperature, with which it is possible to determine whether or not dew condensation occurs on the nozzle surface 1a.

### Humidity Sensor

The liquid discharge apparatus 103 includes a humidity sensor 62. The humidity sensor 62 is electrically coupled to the controller 500. The humidity sensor 62 detects humidity in a vicinity of the liquid discharge head 10. The humidity sensor 62 detects, for example, humidity in a vicinity of the nozzle surface 1a. The humidity sensor 62 detects humidity inside the housing of the liquid discharge apparatus 103. Data of humidity detected by the humidity sensor 62 may be data of humidity, with which it is possible to determine whether or not dew condensation occurs on the nozzle surface 1a.

The liquid discharge apparatus 103 may include a sensor that can detect other data. The liquid discharge apparatus 103 may include a sensor that detects a temperature of the liquid discharge head 10. The liquid discharge apparatus 103 may include a sensor that detects a temperature of the fluid for temperature adjustment for the head temperature adjuster 20. The liquid discharge apparatus 103 may include sensors that detect a color and density of an image formed on a recording medium P.

### Head Controller

The controller 500 includes a head controller 521 that controls driving of the liquid discharge head 10. The head controller 521 can control operation of a head driver 17 provided for driving the liquid discharge head 10. The head driver 17 is mounted on the head unit 3, and is electrically coupled to the liquid discharge head 10. The head driver 17 is also referred to as a driver integrated circuit (IC). The head controller 521 can control drive elements in the liquid discharge head 10 to execute discharging of a liquid. The head controller 521 can execute various controls related to the liquid discharge head 10.

The head controller 521 includes a drive signal generator that generates a drive signal for controlling driving of the liquid discharge head 10 and a data transferer that transfers the drive signal to the head driver 17.

The controller 500 transfers image data having undergone processing from the head controller 521 to the head driver 17.

The head controller 521 can transfer the image data described above in a form of serial data. The head controller 521 may transfer a transfer clock signal that is necessary for transferring image data and confirming the transferring, for example, to the head driver 17. The head controller 521 can output a latch signal and a control signal for controlling discharging of the liquid to the head driver 17.

The drive signal generator in the head controller 521 includes a digital (D)/analog (A) converter, a voltage amplifier, and a current amplifier. The D/A converter can perform D/A conversion of pattern data of drive pulses stored in the ROM 502, for example. A drive pulse is included in a drive signal. The voltage amplifier can amplify a voltage based on a drive pulse, for example. The current amplifier may amplify a current based on a drive pulse. The drive signal generator outputs a drive signal including one drive pulse or a plurality of drive pulses to the head driver 17.

The head driver 17 supplies a voltage based on a drive pulse to the piezoelectric elements to cause the liquid discharge head 10 to discharge the liquid. The head controller 521 selects a drive pulse, making it possible to separately discharge dots that vary in size, such as large droplets, medium droplets, and small droplets.

### Motor Driver

The liquid discharge apparatus 103 includes a plurality of motors 51 to 53. The medium conveyor 50 includes the plurality of motors 51 to 53. The motor 51 may be a motor that drives the unwinder 5. The motor 52 may be a motor that drives a conveyance roller. The motor 53 may be a motor that drives the rewinder 7. The liquid discharge apparatus 103 may include a motor for opening or closing the cap 40.

The controller 500 includes a motor driver 522. The motor driver 522 controls driving of the plurality of motors 51 to 53. The motor driver 522 may control driving of other motors. The motor driver 522 controls driving of the plurality of motors 51 to 53 in accordance with an instruction provided from the CPU 501.

The motor driver 522 controls rotating and stopping of various motors. The motor driver 522 can control rotating and stopping of the plurality of motors 51 to 53 to control conveyance of a recording medium P. The motor driver 522 can control rotating and stopping of the plurality of motors 51 to 53 to control a conveyance speed for a recording medium P.

### Head temperature adjuster Driver

The controller 500 includes a head temperature adjuster driver 523. The head temperature adjuster driver 523 can control operation of the head temperature adjuster 20. The head temperature adjuster driver 523 may control, for example, driving of a pump that transfers the fluid for temperature adjustment.

### Drying Driver

The controller 500 includes a drying driver 524. The drying driver 524 can control operation of the dryer 6. The drying driver 524 may control a temperature of a heater for the dryer 6.

### Functional Configuration

Next, a functional configuration of the controller 500 will now be described herein. FIG. 7 is a functional block diagram of the controller 500 according to the embodiment of the present embodiment. The CPU 501 illustrated in FIG. 6 executes a program stored in a storage 570 such as the ROM 502 to implement functions of a system controller 531, a memory controller 532, a communication controller 533, a discharge controller 534, an operation mode setter 535, a drying temperature controller 541, a conveyance speed controller 542, a head temperature adjuster controller 543, and the storage 570 illustrated in FIG. 7. An external device and a sensor coupled to the controller 500 may execute some of the functions.

The system controller 531 controls entire operation of the liquid discharge apparatus 103. The memory controller 532 controls operation of memories such as the ROM 502, the RAM 503, and the NVRAM 504. The communication controller 533 performs control for communication with an external device coupled to the control device 510.

The discharge controller 534 controls discharging of the liquid by the liquid discharge head 10. Operation of the liquid discharge head 10 is controlled.

The operation mode setter 535 can set an operation mode in the liquid discharge apparatus 103. The liquid discharge apparatus 103 can execute a plurality of operation modes. The operation mode setter 535 can change a setting of the operation mode to execute a different operation mode. The operation mode may include a printing mode. The printing mode may be an image quality formation mode. The liquid discharge apparatus 103 may change the operation mode in accordance with a type of a recording medium P, for example. The liquid discharge apparatus 103 may change the operation mode to change various settings. The liquid discharge apparatus 103 can change the operation mode to change settings in the head temperature adjuster 20, settings in the medium conveyor 50, and settings in the dryer 6.

The plurality of operation modes may include a liquid discharge mode and a moisturizing mode. The liquid discharge mode may be a printing mode under which it is possible to allow the liquid discharge head 10 to discharge the ink to execute printing. The liquid discharge mode may include a state of executing preparation before execution of printing and a state of executing post-processing after execution of printing. The liquid discharge mode may include a state of conveying a recording medium P. The liquid discharge mode may include a state of heating the dryer 6 to a predetermined temperature.

The operation mode setter 535 may set the operation mode based on an operation input provided by the user. For example, when it is detected an operation input with which the user prompts start of printing, the operation mode may be switched to the liquid discharge mode. The operation mode setter 535 may set the liquid discharge mode after a timing at which the operation input with which the user prompts start of printing is detected.

The moisturizing mode is an operation mode under which printing is not to be executed, and may be an operation mode under which it is possible to cover the nozzle surface 1a with the cap 40 to moisturize the ink in the nozzles N. The moisturizing mode is an example of a case where discharge operation is not to be performed for a certain period of time.

The plurality of operation modes may include a maintenance mode. The maintenance mode may be an operation mode for executing an operation of maintaining or recovering the function of the liquid discharge head 10.

The maintenance mode may include an operation mode for executing an operation (a dummy discharge operation) of allowing the nozzles N to discharge the ink that does not contribute to printing. The maintenance mode may include an operation mode for executing an operation of sucking and removing the ink in the nozzles N. The maintenance mode may include an operation mode for executing a wiping operation for wiping off foreign matter (ink droplets) adhered onto the nozzle surface 1a.

The drying temperature controller 541 controls a set temperature in the dryer 6. The dryer 6 can heat a recording medium P to allow a temperature of the recording medium P to reach a set temperature.

The conveyance speed controller 542 can set a conveyance speed for a recording medium P conveyed by the medium conveyor 50. For example, the motor driver 522 can control driving of the plurality of motors 51 to 53 to achieve a set conveyance speed. The conveyance speed controller 542 can control a conveyance speed of the unwinder 5, a conveyance speed of the rewinder 7, and a conveyance speed of the conveyance roller.

The head temperature adjuster controller 543 controls a set temperature in the head temperature adjuster 20. The head temperature adjuster 20 can heat the liquid discharge head 10 to allow the nozzle surface 1a of the liquid discharge head 10 to reach the set temperature. The head temperature adjuster controller 543 may control a set temperature in the head temperature adjuster 20 to allow a temperature of the nozzle surface 1a to be equal to or higher than a dew point temperature during printing. The head temperature adjuster controller 543 can set, during non-printing, the set temperature in the head temperature adjuster 20 to a temperature different from the temperature during printing. The head temperature adjuster 20 can change a temperature of the fluid for temperature adjustment in accordance with the set temperature that has been set by the head temperature adjuster controller 543. A set temperature in the head temperature adjuster 20 may be a temperature that has been set based on a temperature of the temperature adjustment liquid, a temperature that has been set based on a temperature of the nozzle surface 1a, or a temperature that has been set based on the heater in the head temperature adjuster 20. A set temperature in the head temperature adjuster 20 may be a temperature that has been set based on a determination of whether or not dew condensation occurs on the nozzle surface 1a.

A set temperature in the head temperature adjuster 20 may be a temperature that has been set based on a temperature of the ink, or may be a temperature that has been set based on a temperature of the head (a temperature of the liquid discharge head 10). An object of temperature adjustment for the liquid discharge head 10 using the head temperature adjuster 20 is to suppress a decrease in viscosity of an ink, which may occur due to an increase in temperature when the liquid discharge head 10 is driven and an increase in temperature of the ink in the liquid chamber inside the liquid discharge head 10. The liquid discharge head 10 is provided with a thermistor (a temperature sensor) for measuring a temperature of the ink in the liquid chamber. The thermistor is provided in a vicinity of the liquid chamber. The controller 500 can calculate a temperature of the ink in the liquid chamber based on a measurement value of the thermistor in the vicinity of the liquid chamber. A set temperature in the head temperature adjuster 20 may be a temperature that has been set based on a temperature of the ink in the liquid chamber.

The head temperature adjuster controller 543 can control a set temperature in the head temperature adjuster 20 based on an indoor temperature detected by the temperature sensor 61. The head temperature adjuster controller 543 can control a set temperature in the head temperature adjuster 20 based on humidity detected by the humidity sensor 62. The head temperature adjuster controller 543 can control a set temperature based on data of both an indoor temperature and humidity.

The head temperature adjuster controller 543 can adjust a set temperature in the head temperature adjuster 20 based on a type of a recording medium P. The head temperature adjuster controller 543 may detect a tray storing a recording medium P to detect a type of the recording medium P. The head temperature adjuster controller 543 may determine a type of a recording medium P in accordance with an operation input of the user. The head temperature adjuster controller 543 may determine a type of a recording medium P based on other information. The head temperature adjuster controller 543 can change a set temperature based on a thickness of a recording medium P.

For example, heat capacity varies depending on a thickness of a recording medium P. A degree of ease of occurrence of dew condensation onto the nozzle surface 1a varies depending on a thickness of a recording medium P.

The head temperature adjuster controller 543 may adjust a set temperature in the head temperature adjuster 20 based on smoothness of a surface of a recording medium P. Friction generally occurs between a piece of paper and a turn bar used to reverse the front and back surfaces of the piece of paper. When a piece of paper having a high friction coefficient is brought into contact with the turn bar, a temperature of the piece of paper thus increases during back surface printing. When a piece of paper having a high friction coefficient undergoes printing, dew condensation easily occurs on the nozzle surface 1a during back surface printing, compared with a case when a piece of paper having a low friction coefficient undergoes printing. In the liquid discharge apparatus 103, a set temperature in the head temperature adjuster 20 may be allowed to be higher as a friction coefficient when a piece of paper is brought into contact with the turn bar is higher.

The controller 500 may control operation by the head temperature adjuster 20 to allow a temperature of the liquid discharge head 10 to be a high temperature when a friction coefficient between the turn bar used when a recording medium P is inverted and the recording medium is high, compared with a case when a friction coefficient between the turn bar and a recording medium is low.

The head temperature adjuster controller 543 can control a set temperature in the head temperature adjuster 20 based on an indoor temperature detected by the temperature sensor 61 and the operation mode. The head temperature adjuster controller 543 can control a set temperature in the head temperature adjuster 20 based on a conveyance speed for a recording medium P. The conveyance speed may be, for example, a conveyance speed for a recording medium P when the recording medium passes through a position immediately below the nozzle surface 1a.

The head temperature adjuster controller 543 may control a set temperature in the head temperature adjuster 20 to suppress adhesion of dew condensation onto the nozzle surface 1a during printing, and to cool the liquid discharge head 10 to lower its temperature as much as possible. The head temperature adjuster 20 can adjust not only a temperature of the nozzle surface 1a, but also a temperature of the ink inside the liquid discharge head 10. The head temperature adjuster controller 543 may control a set temperature in the head temperature adjuster 20 to suppress adhesion of dew condensation onto the nozzle surface 1a during non-printing, and to not heat the ink in the nozzles N as much as possible. The phrase “during non-printing” may be synonymous with during capping. The head temperature adjuster controller 543 may cause the head temperature adjuster 20 to stop its operation during non-printing.

### Storage

The storage 570 stores various information. The storage 570 can store information related to various settings. The storage 570 may store, for example, a set temperature and a set condition corresponding to an operation mode. The storage 570 can store information related to a dew point temperature. The storage 570 can store a derivation equation for deriving a set temperature in the head temperature adjuster 20. The storage 570 may store data indicating a relationship among humidity in air around the nozzle surface 1a, a temperature of the air around the nozzle surface 1a, and a temperature of the nozzle surface 1a. The storage 570 may store data related to a degree of easiness of adhesion of dew condensation onto the nozzle surface 1a. The data related to the degree of easiness of adhesion of dew condensation onto the nozzle surface 1a includes results of experiments and results of simulations.

### Printing Operation

Before execution of printing operation on a recording medium P, the controller 500 executes temperature control for the dryer 6 to allow the dryer 6 to reach a predetermined temperature. The controller 500 executes conveyance control for the recording medium P in the medium conveyor 50 in synchronization with a timing when printing preparation performed by the dryer 6 is ready.

The controller 500 determines whether or not a printing start condition has been satisfied. The printing start condition may be a condition under which a conveyance speed for a recording medium P is constant and a temperature of the dryer 6 falls within a predetermined range. When it is determined that the printing start condition has been satisfied, the discharge controller 534 in the controller 500 outputs a discharge signal to the liquid discharge head 10. The liquid discharge head 10 discharges the ink based on the discharge signal to form an image on the recording medium P.

The head temperature adjuster controller 543 can control a temperature of the liquid discharge head 10 to adjust the viscosity of the ink. The head temperature adjuster 20 can supply the temperature adjustment liquid having undergone adjustment in temperature to the liquid discharge head 10 to adjust the temperature of the liquid discharge head 10. The head temperature adjuster controller 543 can control a set temperature of the chiller 23 in the head temperature adjuster 20.

### Temperature of Temperature Adjustment Liquid Under Printing Mode

Under the printing mode (the image formation mode), a temperature of the temperature adjustment liquid is set in consideration of quality of an image to be formed on a recording medium P. The controller 500 may set a low temperature for the temperature adjustment liquid to improve the quality of an image. When the liquid discharge head 10 is to be driven, the liquid discharge head 10 is heated, decreasing the viscosity of the ink. As the viscosity of the ink decreases, the quality of an image may decrease. The controller 500 lowers a temperature of the temperature adjustment liquid to adjust the viscosity of the ink, making it possible to suppress deterioration in quality of an image.

Under the printing mode, the temperature of the temperature adjustment liquid may be set in consideration of dew condensation onto the nozzle surface 1a. The head temperature adjuster controller 543 takes into consideration of dew condensation onto the nozzle surface 1a, making it possible to control a set temperature in the head temperature adjuster 20 to a predetermined temperature or a higher temperature. The head temperature adjuster controller 543 can set, under the printing mode, a set temperature at which dew condensation does not occur on the nozzle surface 1a. The head temperature adjuster controller 543 takes into consideration of the quality of an image and dew condensation under the printing mode, making it possible to control a set temperature in the head temperature adjuster 20.

### Dew Condensation on Nozzle Surface

Dew condensation onto the nozzle surface 1a is observed as a phenomenon that, when an amount of water vapor in air around the nozzle surface 1a exceeds an amount of saturated water vapor in the air around the nozzle surface 1a, dew condensation adheres onto the nozzle surface 1a. The phrase “air around the nozzle surface 1a” may be referred to as an “atmosphere around the nozzle surface”. Dew condensation easily occurs on the nozzle surface 1a when “humidity in an atmosphere around the nozzle surface is high” and “a temperature of the nozzle surface 1a is low, with respect to a temperature of the atmosphere around the nozzle surface”. When the humidity in the atmosphere around the nozzle surface is high, dew condensation easily occurs, compared with a case when the humidity is low. When the temperature of the nozzle surface 1a is low, dew condensation easily occurs, compared with a case when the temperature is high. A degree of easiness of adhesion of dew condensation onto the nozzle surface 1a is affected by humidity in air around the nozzle surface 1a, a temperature of the air around the nozzle surface 1a, and a temperature of the nozzle surface 1a.

During printing illustrated in FIG. 4, for example, mist of the ink that is separated from the ink 19 discharged from the nozzle N and that is floating in air increases humidity in air around the nozzle surface 1a. The recording medium P onto which the ink 19 discharged from the upstream liquid discharge head 10 has adhered is conveyed during printing, increasing humidity in air around the nozzle surface 1a that is present above the recording medium P. The mist of the ink that is separated from the ink 19 discharged from the upstream liquid discharge head 10 and that is floating flows downstream, increasing humidity in downstream air.

As the head temperature adjuster 20 adjusts a temperature of the nozzle surface 1a, the temperature of the nozzle surface 1a may be lower than a temperature of air around the nozzle surface 1a. In this case, dew condensation may occur on the nozzle surface 1a.

When dew condensation occurs on the nozzle surface 1a, an abnormality may occur in forming of an image on a recording medium P. When dew condensation occurs on the nozzle surface 1a, foreign matter may adhere onto the recording medium P, resulting in the dirty recording medium.

### Moisturizing of Nozzle Surface by Cap

When the nozzle surface 1a is covered with the cap 40, as illustrated in FIG. 5, the nozzle surface 1a is kept moisturized. During capping as described above, humidity in air around the nozzle surface 1a is kept high. Humidity in air inside the cap 40 is also kept high.

### Humidity in Atmosphere around Nozzle Surface During Printing

Humidity in atmosphere around the nozzle surface during printing is affected by an amount of adhesion of the ink and indoor humidity. The phrase “an amount of adhesion of the ink” refers to an amount of the ink per unit area, which is adhered onto a recording medium P, and may be a maximum amount of adhesion. When an amount of adhesion of the ink is large, humidity in an atmosphere around the nozzle surface is high, compared with a case when an amount of adhesion of the ink is small, allowing dew condensation to easily adhere onto the nozzle surface 1a. A maximum amount of adhesion varies depending on the printing mode. In the liquid discharge apparatus 103, a maximum amount of adhesion is set for each printing mode.

A maximum amount of adhesion may be determined based on a drying limit representing a limit value allowing the ink adhered onto a recording medium P to dry. When the ink at an amount exceeding a maximum amount of adhesion has been adhered onto a recording medium P, rollers that are to be in contact with the recording medium P become dirty due to that the ink has not yet fully dried. In the liquid discharge apparatus 103, an amount of the ink to be adhered onto a recording medium P is limited. The phrase “a maximum amount of adhesion” may be referred to as “a limit amount of adhesion” or “a limit value of an amount of adhesion”. The phrase “an amount of adhesion of the ink” may be referred to as “printing coverage”.

When humidity in an environment in which the liquid discharge apparatus 103 has been installed is high, humidity in an atmosphere around the nozzle surface is high, allowing dew condensation to easily adhere onto the nozzle surface 1a, compared with a case when the humidity in the environment is low. The phrase “an environment in which the liquid discharge apparatus 103 has been set” may be referred to as “an apparatus installation environment”. A degree of influence of humidity in an apparatus installation environment with respect to a degree of easiness of adhesion of dew condensation is generally smaller than a degree of influence of an amount of adhesion of the ink described above. A degree of influence of humidity in an apparatus installation environment with respect to a degree of easiness of adhesion of dew condensation varies depending on an outdoor air exchange rate. An “outdoor air exchange rate” is proportional to, for example, a flow rate of air flowing into the housing of the liquid discharge apparatus 103 per unit time. Outside air refers to air outside the housing of the liquid discharge apparatus 103. A degree of influence of humidity in an apparatus installation environment with respect to a degree of easiness of adhesion of dew condensation varies depending on a structure (a mechanical configuration) inside the liquid discharge apparatus 103.

### Temperature of Atmosphere Around Nozzle Surface During Printing

A temperature of an atmosphere around the nozzle surface during printing is affected by a temperature of a recording medium P that is present immediately below the nozzle surface 1a and an indoor temperature (an outdoor air exchange rate). When a temperature of a recording medium P that is present immediately below the nozzle surface 1a is high, a temperature in an atmosphere around the nozzle surface is high, compared with a case when the temperature is low, allowing dew condensation to easily adhere onto the nozzle surface 1a. A surface temperature of a recording medium P that is present immediately below the nozzle surface 1a varies depending on a storage state of the recording medium P immediately before printing. A storage state of a recording medium P is affected by an indoor temperature.

A temperature of the back surface of a recording medium P varies depending on a type of the recording medium P, the printing mode, and an indoor temperature. A printing speed, a set temperature to be attained by the dryer 6, and a set temperature to be attained by the cooler 65 vary depending on the printing mode.

Conducting experiments makes it possible to confirm an influence of a temperature in an atmosphere around the nozzle surface with respect to a degree of easiness of adhesion of dew condensation. A temperature of the back surface of a recording medium P may increase, compared with a temperature of a front surface, due to a remaining influence of heat to be applied by the dryer 6. A temperature of a recording medium P is affected by a thickness of the recording medium P.

When an indoor temperature is high, dew condensation easily adheres onto the nozzle surface 1a, compared with a case when an indoor temperature is low. A degree of influence of an indoor temperature with respect to a degree of easiness of dew condensation varies depending on an internal structure of the liquid discharge apparatus 103.

### Temperature of Nozzle Surface During Printing

A temperature of the nozzle surface 1a during printing is affected by a temperature of the temperature adjustment liquid in the head temperature adjuster 20 and a temperature of an atmosphere around the nozzle surface. When a temperature of the temperature adjustment liquid is low, a temperature of the nozzle surface 1a is low, compared with a case when a temperature of the temperature adjustment liquid is high, allowing dew condensation to easily adhere onto the nozzle surface 1a. The head temperature adjuster 20 is intended to cool the liquid discharge head 10. When a temperature of the temperature adjustment liquid is increased, the function of cooling the liquid discharge head 10 is deteriorated. It is preferable that a temperature of the temperature adjustment liquid be set to a lowest temperature within a temperature range disallowing dew condensation to adhere onto the nozzle surface 1a.

### Humidity in Atmosphere Around Nozzle Surface During Capping

Humidity in an atmosphere around the nozzle surface during capping is affected by a structure of the cap 40. For example, when there is a large gap between the nozzle surface 1a and the cap 40, humidity in an atmosphere around the nozzle surface is low, compared with a case when there is a small gap. The phrase “during capping” refers to a state where the nozzle surface 1a is covered with the cap 40.

### Temperature of Atmosphere Around Nozzle Surface During Capping

A temperature of an atmosphere around the nozzle surface during capping is affected by an indoor temperature. When an indoor temperature is high, a temperature of an atmosphere around the nozzle surface is high, compared with a case when an indoor temperature is low.

### Temperature of Nozzle Surface During Capping

A temperature of the nozzle surface 1a during capping is affected by a temperature of the temperature adjustment liquid and a temperature of an atmosphere around the nozzle surface.

### Relationship Between Indoor Temperature and Set Temperature in Head Temperature Adjuster

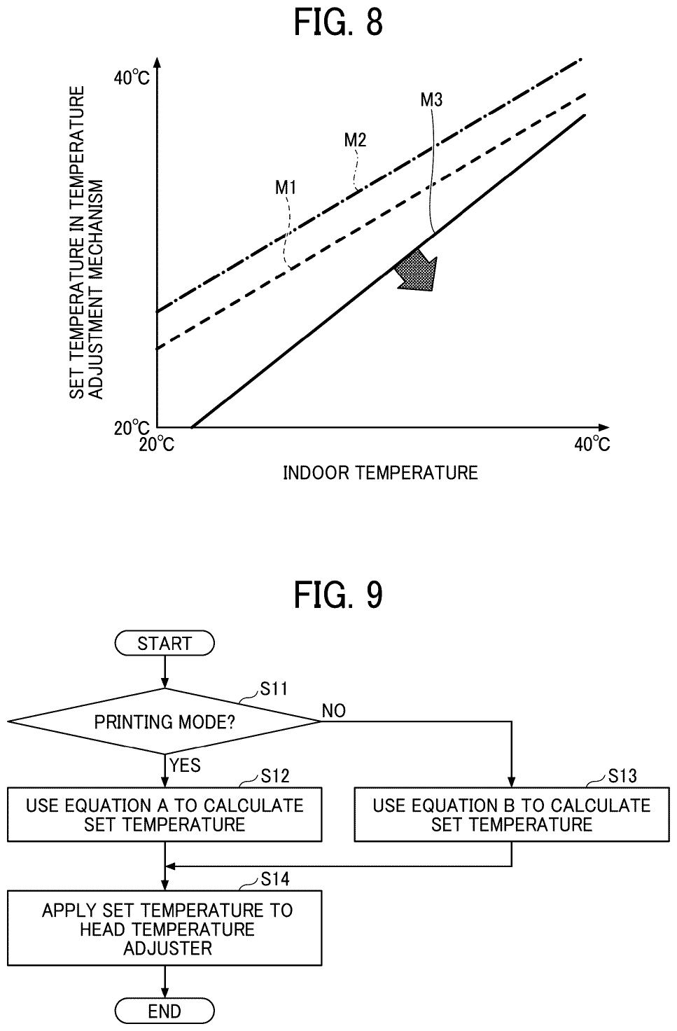

Next, a relationship between an indoor temperature and a set temperature in the head temperature adjuster 20 will now be described herein. FIG. 8 is a graph illustrating a relationship between an indoor temperature and a set temperature in the head temperature adjuster 20. In FIG. 8, a horizontal axis represents an indoor temperature, and a vertical axis represents a set temperature in the head temperature adjuster 20. The set temperature in the head temperature adjuster 20 is proportional to the indoor temperature.

Set temperatures under a first printing mode M1 and a second printing mode M2 are each higher than a set temperature under a moisturizing mode M3. In other words, the set temperature under the moisturizing mode M3 is lower than each of the set temperatures under the first printing mode M1 and the second printing mode M2. When a lower set temperature is set to than the set temperature under the moisturizing mode M3, dew condensation easily adheres onto the nozzle surface 1a. In other words, it is possible to set a set temperature under the moisturizing mode M3 to a set temperature equal to or higher than a temperature at which dew condensation easily adheres. The case where “dew condensation easily adheres” may correspond to a case where liquid droplets generated due to dew condensation easily adhere. For example, the first printing mode M1 may be a printing mode for performing printing on a recording medium P that is a piece of thin paper. The second printing mode M2 may be a printing mode for performing printing on a recording medium P that is a piece of thick paper. For example, the first printing mode M1 may be an operation mode when a conveyance speed for a recording medium P is low. The second printing mode M2 may be an operation mode when a conveyance speed for a recording medium P is high. One reason for this is as follows. After having undergone surface printing and heating by the dryer 6, a recording medium P is cooled by the cooler 65. As a thickness of a piece of paper increases, or a conveyance speed increases, cooling of the recording medium P by the cooler 65 tends to be insufficient. During back surface printing, in particular, a temperature of a recording medium P easily increases, and a temperature of an atmosphere therefore easily increases. Dew condensation thus easily occurs when a temperature of the liquid discharge head 10 is low. To prevent this phenomenon in the liquid discharge apparatus 103, a set temperature to be attained by the head temperature adjuster 20 is increased to increase a temperature of the nozzle surface.

A set temperature under the moisturizing mode M3 may be a set temperature equal to or lower than a temperature allowing dew condensation to easily adhere onto the nozzle surface 1a. The head temperature adjuster controller 543 can control a set temperature based on the relationship between the indoor temperature and the set temperature in the head temperature adjuster 20, as illustrated in FIG. 8. The head temperature adjuster 20 can set each of set temperatures under the first printing mode M1 and the second printing mode M2 to a set temperature exceeding a temperature allowing dew condensation to easily adhere onto the nozzle surface 1a, making it possible to suppress adhesion of dew condensation onto the nozzle surface 1a.

### Example of Processing in Controller

FIG. 9 is a flowchart illustrating an example of processing performed in the controller 500. The controller 500 first determines whether or not the operation mode of the liquid discharge apparatus 103 is the printing mode (step S11). The operation mode setter 535 in the controller 500 can determine the current operation mode of the liquid discharge apparatus 103. The controller 500 executes step S12 in the processing when the printing mode is under execution (step S11; YES), or executes step S13 when the moisturizing mode M3 is under execution (step S11; NO). The controller 500 may determine whether or not the nozzle surface 1a is covered with the cap 40 to determine whether or not the moisturizing mode M3 is under execution. The printing mode may include, as described above, the first printing mode M1 and the second printing mode M2.

At step S12, the controller 500 uses Equation A to calculate a set temperature in the head temperature adjuster 20. Equation A may be, for example, an equation indicating a relationship between an indoor temperature and a set temperature, as illustrated in FIG. 8. Equation A may be, for example, an equation related to the first printing mode M1 or an equation related to the second printing mode M2. The head temperature adjuster controller 543 in the controller 500 can derive a set temperature in accordance with a type of the printing mode. At step S12, for example, the controller 500 can select Equation A for calculating a set temperature in accordance with a paper thickness (a piece of thin paper or thick paper) of a recording medium P. At step S12, for example, the controller 500 can select Equation A for calculating a set temperature in accordance with a conveyance speed for a recording medium P.

At step S13, the controller 500 uses Equation B to calculate a set temperature in the head temperature adjuster 20. Equation B may be, for example, an equation indicating a relationship between an indoor temperature and a set temperature, as illustrated in FIG. 8. Equation B may be, for example, an equation related to the moisturizing mode M3.

After execution of step S12 or step S13 in the processing, the controller 500 executes step S14 in the processing. At step S14, the controller 500 applies the set temperature calculated at step S12 or step S13 to the head temperature adjuster 20. The head temperature adjuster controller 543 in the controller 500 can control the head temperature adjuster 20 to reach the set temperature. The set temperature may be a value related to a temperature of the nozzle surface 1a, or may be a temperature of the temperature adjustment liquid. The set temperature may be a temperature related to whether or not dew condensation adheres onto the nozzle surface 1a. The controller 500 can change the set temperature in the head temperature adjuster 20 based on an indoor temperature and the operation mode.

### Working and Effects of Liquid Discharge Apparatus According to Embodiment

The liquid discharge apparatus 103 according to the embodiment includes the liquid discharge head 10 that has the nozzle surface 1a and discharges a liquid, the head temperature adjuster 20 that adjusts a temperature of the liquid discharge head 10, the cap 40 that covers the nozzle surface 1a, the temperature sensor 61 that detects an indoor temperature, and the controller 500 that controls the head temperature adjuster 20 based on the indoor temperature detected by the temperature sensor 61.

With the liquid discharge apparatus 103 as described above, the head temperature adjuster 20 is controlled based on an indoor temperature, making it possible to adjust a temperature of the liquid discharge head 10. It is thereby possible to appropriately keep a temperature of the liquid discharge head 10, making it possible to suppress adhesion of dew condensation onto the nozzle surface 1a. With the liquid discharge apparatus 103, the nozzle surface 1a is covered with the cap 40 when no ink is to be discharged, making it possible to suppress drying of the ink in the nozzles N. It is thereby possible to suppress an increase in viscosity of the ink in the nozzles N. As a result, it is possible to improve reliability of the liquid discharge apparatus 103. As described above, it is possible to provide a liquid discharge apparatus that can suppress drying of a liquid in a state where the liquid is not to be discharged and of suppressing adhesion of dew condensation onto a nozzle surface in a state where the liquid is to be discharged.

In the liquid discharge apparatus 103, the controller 500 causes the head temperature adjuster 20 to stop temperature adjustment when the liquid discharge head 10 does not execute discharge operation for a certain period of time (for example, approximately one hour). It is thereby possible to save power in the liquid discharge apparatus 103. Causing the head temperature adjuster 20 to stop temperature adjustment makes it possible to allow a temperature of the ink in the nozzles during standing by to be substantially equal to a temperature of an atmosphere around the nozzle surface, making it possible to prevent the nozzle surface from being adhered with dew condensation, to suppress drying of the ink in the nozzles, and to suppress occurrence of abnormality in the nozzles. The phrase “abnormality in the nozzles” may be referred to as a phenomenon that discharging of a liquid from the nozzles N is impossible. In the liquid discharge apparatus 103, the operation mode may be set to the moisturizing mode to cause the head temperature adjuster 20 to stop temperature adjustment. Under the moisturizing mode, the liquid discharge head 10 does not execute liquid droplet discharge operation.

In the liquid discharge apparatus 103, the cap 40 is filled with the wetting liquid in a state where the nozzle surface 1a is covered with the cap 40. The wetting liquid in the cap 40 evaporates, making it thereby possible to improve moisturizing property, and to suppress drying of the ink in the nozzles N.

The liquid discharge apparatus 103 includes the plurality of liquid discharge heads 10. The plurality of nozzle surfaces 1a of the plurality of liquid discharge heads 10 is covered with the cap 40. It is thereby possible to allow the plurality of nozzle surfaces 1a to be covered with one cap 40. As a result, in the liquid discharge apparatus 103, it is possible to reduce a number of installed caps 40, simplifying the apparatus.

The liquid discharge apparatus 103 according to the embodiment includes the liquid discharge head 10 that has the nozzle surface 1a and discharges a liquid, the head temperature adjuster 20 that adjusts a temperature of the liquid discharge head 10, the cap 40 that covers the nozzle surface 1a, the temperature sensor 61 that detects an indoor temperature, and the controller 500 that controls the head temperature adjuster 20 based on the temperature detected by the temperature sensor 61 and an operation mode. The operation mode includes the printing mode (the liquid discharge mode) for discharging the liquid from the liquid discharge head 10 and the moisturizing mode for covering the nozzle surface 1a with the cap 40 for moisturizing.

With the liquid discharge apparatus 103 as described above, the head temperature adjuster 20 is controlled based on an indoor temperature and the operation mode, making it possible to adjust a temperature of the liquid discharge head 10. It is thereby possible to appropriately keep a temperature of the liquid discharge head 10, making it possible to suppress adhesion of dew condensation onto the nozzle surface 1a. With the liquid discharge apparatus 103, it is possible to allow the head temperature adjuster 20 to change temperature control in accordance with a determination of whether or not the operation mode is the printing mode or the moisturizing mode. With the liquid discharge apparatus 103, the nozzle surface 1a is covered with the cap 40 when no ink is to be discharged, making it possible to suppress drying of the ink in the nozzles N. As a result, it is possible to suppress an increase in viscosity of the ink in the nozzles N. As a result, it is possible to improve the reliability of the liquid discharge apparatus 103.

The liquid discharge apparatus 103 includes the medium conveyor 50 that conveys a recording medium P. The controller 500 controls the head temperature adjuster 20 based on a type of the recording medium P. It is thereby possible to allow the head temperature adjuster 20 to change temperature adjustment in accordance with a recording medium P. As a result, with the liquid discharge apparatus 103, it is possible to appropriately keep a temperature of the liquid discharge head 10 in accordance with a type of a recording medium P, making it possible to suppress adhesion of dew condensation onto the nozzle surface 1a.

In the liquid discharge apparatus 103, the controller 500 controls the head temperature adjuster 20 to allow a temperature of the liquid discharge head 10 to be a high temperature when the thickness of a recording medium P is thick (for example, 250 μm), compared with a case when the thickness of a recording medium P is thin. With the liquid discharge apparatus 103, it is possible to increase the temperature of the nozzle surface 1a, as the thickness of a recording medium P increases, making it possible to suppress adhesion of dew condensation onto the nozzle surface 1a. For example, when the thickness of a recording medium P is thick, the controller 500 may set a high temperature for the nozzle surface 1a of the liquid discharge head 10 on a downstream side, from which the ink is to be discharged with respect to the back surface of the recording medium P, compared with a case when the thickness of a recording medium P is thin. The controller 500 may set a high temperature for the liquid discharge head 10 in accordance with the thickness of a recording medium P when a value of the thickness of the recording medium P is equal to or greater than a reference value (for example, 250 μm), and may set a value of a temperature of the liquid discharge head 10 to a constant value when a value of the thickness of a recording medium P is smaller than the reference value. The phrase “a case when the thickness of a recording medium P is thick” corresponds to “a case when the thickness of a recording medium corresponds to a second thickness that is thicker than a first thickness”.

The liquid discharge apparatus 103 includes the humidity sensor 62 that detects humidity in a vicinity of the liquid discharge head 10. The controller 500 controls, when the humidity is high, the head temperature adjuster 20 to allow a temperature of the liquid discharge head 10 to be a high temperature, compared with a case when the humidity is low. With the liquid discharge apparatus 103, it is possible to increase a temperature of the nozzle surface 1a, as humidity increases, making it possible to suppress adhesion of dew condensation onto the nozzle surface 1a. In the liquid discharge apparatus 103, it is possible to set a high temperature for the nozzle surface 1a in accordance with an increase in humidity in an atmosphere around the nozzle surface during printing. For example, when the humidity sensor 62 has detected high humidity, the controller 500 may set a high temperature for the nozzle surface 1a of the liquid discharge head 10 on a downstream side, from which the ink is to be discharged with respect to the back surface of a recording medium P, compared with a case when the humidity is low. The phrase “a case when humidity is high” corresponds to “a case when humidity corresponds to second humidity that is higher than first humidity”.

The liquid discharge apparatus 103 includes the medium conveyor 50 that conveys a recording medium P. When a conveyance speed for the recording medium P is high (for example, 150 m/min), the controller 500 controls the head temperature adjuster 20 to allow a temperature of the liquid discharge head 10 to be a high temperature, compared with a case when a conveyance speed is low (for example, 100 m/min). With the liquid discharge apparatus 103, it is possible to increase a temperature of the nozzle surface 1a, as a conveyance speed for a recording medium P increases, making it possible to suppress adhesion of dew condensation onto the nozzle surface 1a. For example, in a case when a conveyance speed is high, the controller 500 may set a high temperature for the nozzle surface 1a of the liquid discharge head 10 on the downstream side, from which the ink is to be discharged with respect to the back surface of a recording medium P, compared with a case when a conveyance speed is low. The phrase “a case when a conveyance speed is high” means “a case when a conveyance speed corresponds to a second speed that is higher than a first speed”.

The liquid discharge apparatus 103 includes the dryer 6 that dries the recording medium P onto which the liquid has been discharged. The controller 500 controls the head temperature adjuster 20 to allow a temperature of the liquid discharge head 10 to be a high temperature when a set temperature to be attained by the dryer 6 is high (for example, 120° C.), compared with a case when a set temperature to be attained by the dryer 6 is low (for example, 60° C.). With the liquid discharge apparatus 103, it is possible to increase a temperature of the nozzle surface 1a, as a set temperature to be attained by the dryer 6 increases, making it possible to suppress adhesion of dew condensation onto the nozzle surface 1a. For example, in a case when a set temperature in the dryer 6 is high, the controller 500 may set a high temperature for the nozzle surface 1a of the liquid discharge head 10 on the downstream side, from which the ink is to be discharged with respect to the back surface of a recording medium P, compared with a case when a set temperature in the dryer 6 is low. The phrase “a case when a set temperature to be attained by the dryer is high” refers to “a case when a set temperature to be attained by the dryer corresponds to a second temperature that is higher than a first temperature”.

The liquid discharge apparatus 103 includes the medium conveyor 50 that conveys roll paper representing a recording medium P. The nozzle surface 1a extends in a direction intersecting the conveyance direction of the recording medium P. The direction intersecting the conveyance direction of a recording medium P corresponds to a width direction of the recording medium P. The liquid discharge apparatus 103 may be a continuous printer. The liquid discharge head 10 may be a line head. In a continuous printer having a line head, generally, adhesion of dew condensation onto the nozzle surface 1a tends to increase. With the liquid discharge apparatus 103, it is possible to suppress adhesion of dew condensation onto the nozzle surface 1a.

A recording medium P has the first surface and the second surface facing each other in the thickness direction. The liquid discharge head 10 discharges the liquid onto the first surface and the second surface. The liquid discharge apparatus 103 may be an image forming apparatus that can perform both-side printing. In an image forming apparatus that can perform both-side printing, generally, adhesion of dew condensation onto the nozzle surface 1a tends to increase. With the liquid discharge apparatus 103, it is possible to suppress adhesion of dew condensation onto the nozzle surface 1a.

In the liquid discharge apparatus 103, the controller 500 controls the head temperature adjuster 20 to allow the liquid discharge head 10 to be set temperatures different from each other in a state where the liquid discharge head 10 discharges the liquid and a state where the nozzle surface 1a is covered with the cap 40. In the liquid discharge apparatus 103, as described above, it is possible to change a temperature of the nozzle surface 1a depending on whether or not the mode is the printing mode or the moisturizing mode. In the moisturizing mode, for example, a set temperature to be attained by the head temperature adjuster 20 may be lowered to save power. Under the printing mode, for example, increasing a set temperature to be attained by the head temperature adjuster 20 makes it possible to suppress adhesion of dew condensation onto the nozzle surface 1a.

In the liquid discharge apparatus 103, the controller 500 controls the head temperature adjuster 20 to allow the temperature of the nozzle surface 1a to be a temperature at which dew condensation does not occur on the nozzle surface 1a. Conducting experiments and simulations, for example, makes it possible to calculate a temperature at which dew condensation does not occur on the nozzle surface 1a. The liquid discharge apparatus 103 allows a set temperature in the head temperature adjuster 20 to be a temperature at which dew condensation does not occur on the nozzle surface 1a, making it possible to suppress adhesion of dew condensation onto the nozzle surface 1a.

In the liquid discharge apparatus 103, the controller 500 controls the head temperature adjuster 20 to allow a temperature of the liquid discharge head 10 to be a high temperature when the temperature sensor 61 has detected a high indoor temperature, compared with a case when the temperature sensor 61 has detected a low indoor temperature. With the liquid discharge apparatus 103, it is possible to increase a temperature of the nozzle surface 1a, as an indoor temperature increases, making it possible to suppress adhesion of dew condensation onto the nozzle surface 1a. For example, when the temperature sensor 61 has detected a high indoor temperature, the controller 500 may set a high temperature for the nozzle surface 1a of the liquid discharge head 10 on the downstream side, from which the ink is to be discharged onto the back surface of a recording medium P, compared with a case when the temperature is lower than an indoor temperature that the temperature sensor 61 has detected. The phrase “when the temperature sensor has detected a high temperature” refers to “when a temperature that the temperature sensor has detected corresponds to a second temperature that is higher than a first temperature”.

The controller 500 (circuitry) controls the head temperature adjuster 20 to adjust the head temperature to a first temperature when the medium P has a first thickness, and the controller 500 (circuitry) controls the head temperature adjuster 20 to adjust the head temperature to a second temperature higher than the first temperature when the medium P has a second thickness thicker than the first thickness.

The liquid discharge apparatus 103 includes a humidity sensor 62 to detect humidity in a vicinity of the liquid discharge head 10. The controller 500 (circuitry) controls the head temperature adjuster 20 to adjust the head temperature to a first temperature when the humidity detected by the humidity sensor 62 is lower than a humidity threshold, and the controller 500 (circuitry) controls the head temperature adjuster 20 to adjust the head temperature to a second temperature higher than the first temperature when the humidity detected by the humidity sensor 62 is higher than the humidity threshold.

The liquid discharge apparatus 103 includes a medium conveyor 50 to convey the medium at a first speed or a second speed faster than the first speed, wherein the controller 500 (circuitry) controls the head temperature adjuster 20 to adjust the head temperature to a first temperature when the medium conveyor 50 conveys the medium at the first speed, and the controller 500 (circuitry) controls the head temperature adjuster 20 to adjust the head temperature to a second temperature higher than the first temperature when the medium conveyor 50 conveys the medium at the second speed.

The liquid discharge apparatus 103 includes a dryer 6 to dry the medium P, onto which the liquid has been discharged, with a first drying temperature or a second drying temperature higher than the first drying temperature, wherein the controller 500 (circuitry) controls the head temperature adjuster 20 to adjust the head temperature to a first temperature when the dryer 6 is set to the first drying temperature, and the controller 500 (circuitry) controls the head temperature adjuster 20 to adjust the head temperature to a second temperature higher than the first temperature when the dryer 6 is set to the second drying temperature.

The liquid discharge apparatus 103 includes a medium conveyor 50 to convey a roll paper in a conveyance direction, wherein the nozzles N on the nozzle surface 1a are arrayed in a direction intersecting the conveyance direction. The medium P has a first surface and a second surface opposite to the first surface, and the liquid discharge head 10 discharges the liquid onto each of the first surface and the second surface.

The liquid discharge apparatus 103 includes a cap 40 to cover the nozzle surface 1a, wherein the controller 500 (circuitry) controls the head temperature adjuster 20 to adjust the head temperature to a first temperature when the liquid discharge head 10 discharges the liquid, and the controller 500 (circuitry) controls the head temperature adjuster 20 to adjust the head temperature to a second temperature different from the first temperature when the cap 40 covers the nozzle surface 1a.

The controller 500 (circuitry) controls the head temperature adjuster 20 to adjust the head temperature to a first temperature when the indoor temperature or the nozzle surface temperature detected by the temperature sensor 61 is lower than a temperature threshold, and the controller 500 (circuitry) controls the head temperature adjuster 20 to adjust the head temperature to a second temperature higher than the first temperature when the indoor temperature or the nozzle surface temperature detected by the temperature sensor 61 is higher than the temperature threshold.

In the liquid discharge apparatus 103, the head temperature adjuster 20 includes the circulation channel in which the fluid for temperature adjustment is allowed to circulate. The fluid for temperature adjustment is allowed to circulate, making it possible to adjust a temperature of the liquid discharge head 10. With the liquid discharge apparatus 103, the fluid for temperature adjustment is allowed to circulate, making it possible to stably keep a temperature of the nozzle surface 1a.

In the liquid discharge apparatus 103, the liquid may be an aqueous pigment ink. In an image forming apparatus that discharges an aqueous pigment ink, a temperature of the nozzle surface 1a is adjusted, making it possible to suppress adhesion of dew condensation onto the nozzle surface 1a. In a case of the aqueous pigment ink, water vapor generally occurs. Dew condensation also easily adheres onto the nozzle surface 1a. With the liquid discharge apparatus 103, however, it is possible to suppress adhesion of dew condensation onto the nozzle surface 1a.

An object of temperature adjustment for the liquid discharge head 10 by the head temperature adjuster 20 is to suppress a decrease in viscosity of an ink in the liquid chamber due to an increase in temperature during head driving. When the head temperature adjuster 20 allows the ink to be cooled for adjusting viscosity of the ink, for example, a temperature of the nozzle surface 1a may decrease, thereby causing dew condensation to occur onto the nozzle surface 1a. With the liquid discharge apparatus 103 and in the liquid discharge apparatus 103 according to the present embodiment, the head temperature adjuster 20 is controlled based on an indoor temperature, making it possible to adjust a temperature of the liquid discharge head 10. It is thereby possible to appropriately keep a temperature of the liquid discharge head 10, making it possible to suppress adhesion of dew condensation onto the nozzle surface 1a. In the liquid discharge head 10, for example, a heat insulating material may be provided between the liquid chamber and the nozzle surface 1a. In the liquid discharge apparatus 103 according to the present embodiment, however, adjusting a temperature of the liquid discharge head 10 suppresses occurrence of dew condensation onto the nozzle surface 1a, making it possible to suppress adhesion of dew condensation onto the nozzle surface 1a without providing a heat insulating material between the liquid chamber and the nozzle surface 1a.

### Liquid Discharge System

Next, a liquid discharge system 100 will now be described herein. FIG. 10 is a schematic view illustrating an example of the liquid discharge system 100 according to the embodiment of the present embodiment. The liquid discharge system 100 illustrated in FIGS. 10 to 12 includes a client personal computer (PC) 101, a digital front end (DFE) 102, the liquid discharge apparatus 103, and a management server 104. The components are communicably coupled to each other via the Internet, for example. The liquid discharge system 100 may be an image forming system. The liquid discharge system 100 (the image forming system) may include the liquid discharge apparatus 103 (the image forming apparatus).

The client PC 101 creates a print job for desired printing by the user, and transmits the print job to the DFE 102 or the management server 104. A display portion that is a liquid crystal display and an input device including a mouse and a keyboard, for example, are provided.

The DFE 102 receives the print job from the client PC 101 or the management server 104, uses a raster image processor (RIP) engine to create rendering data based on the received print job, and transmits the rendering data to the liquid discharge apparatus 103. The DFE 102 may be an information processing apparatus.

The liquid discharge apparatus 103 forms an image on a recording medium P based on the rendering data received from the DFE 102. The management server 104 manages the print job received from the client PC 101. The management server 104 transmits the print job to the DFE 102 in response to a request from the DFE 102. A plurality of the liquid discharge apparatuses 103 and a plurality of the client PCs 101 may be communicably coupled to the liquid discharge system 100.

### Hardware of DFE

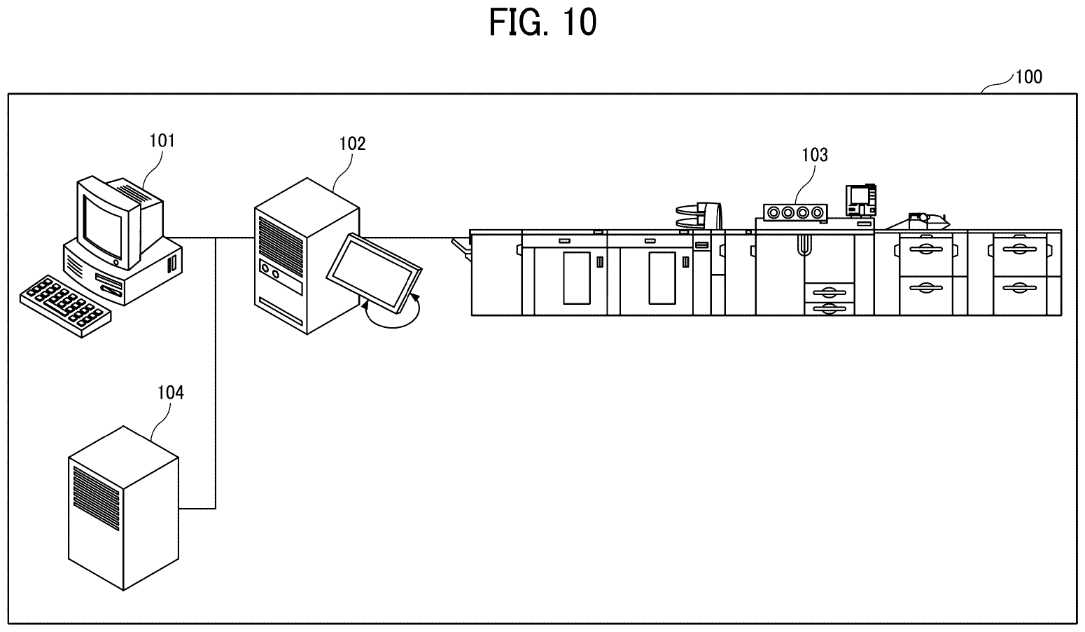

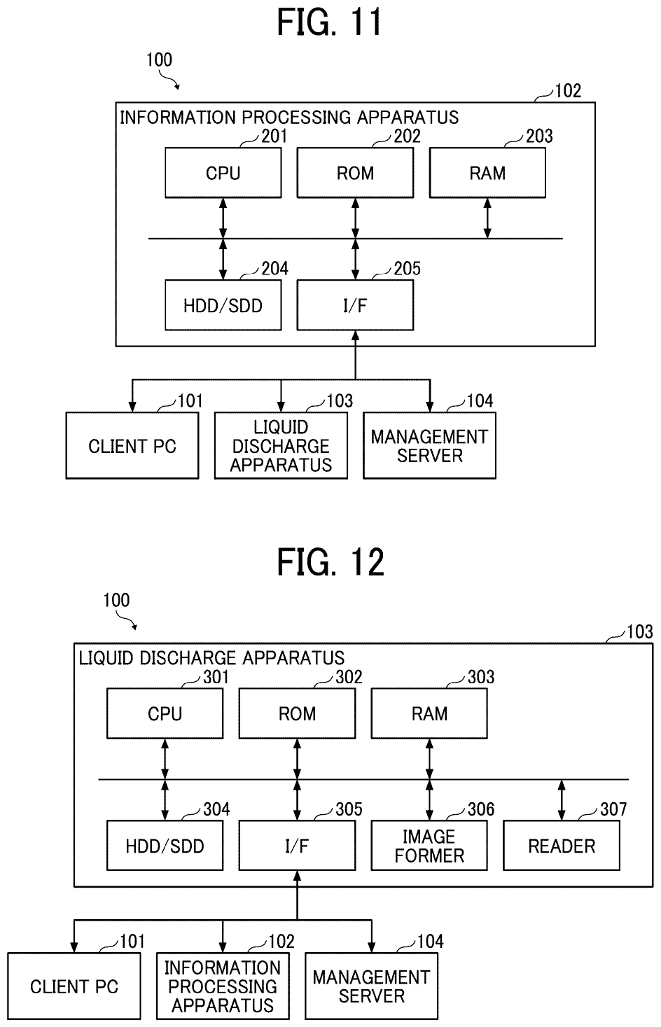

Next, a hardware configuration example of the DFE 102 will now be described herein. FIG. 11 is a block diagram illustrating a hardware configuration of the DFE 102 according to the embodiment of the present embodiment. The DFE 102 includes a central processing unit (CPU) 201, a read only memory (ROM) 202, a random access memory (RAM) 203, a hard disk drive (HDD)/solid state drive (SSD) 204, and an interface (I/F) 205.

Among the components, the CPU 201 uses the RAM 203 as a work area, and executes a program stored in the ROM 202 to control entire operation of the DFE 102. The HDD/SDD 204 is used as a storage for storing preset setting values.

The CPU 201 may use information stored in the HDD/SSD 204 when executing the read program. The I/F 205 is an interface that enables the DFE 102 to communicate with the client PC 101, the liquid discharge apparatus 103, and the management server 104.

### Hardware of Liquid Discharge Apparatus

Next, a hardware configuration of the liquid discharge apparatus 103 will now be described herein. FIG. 12 is a block diagram illustrating a hardware configuration of the liquid discharge apparatus 103 according to the embodiment of the present embodiment. The liquid discharge apparatus 103 includes a CPU 301, a ROM 302, a RAM 303, an HDD/SSD 304, an I/F 305, an image former 306, and a reader 307. The image former 306 may be a liquid discharger.

Among the components, the CPU 301 uses the RAM 303 as a work area, and executes a program stored in the ROM 302 to control entire operation of the liquid discharge apparatus 103. The HDD/SDD 304 is used as a storage for storing preset setting values. The CPU 301 may use information stored in the HDD/SSD 304 when executing the read program.

The I/F 305 is an interface that enables the liquid discharge apparatus 103 to communicate with the DFE 102, the client PC 101, and the management server 104. The image former 306 is a printing engine that forms a print image on a piece of printing paper (a recording medium P). The reader 307 is a reading device that reads a print image formed on a piece of printing paper.

### Liquid Discharge System According to Embodiment

The liquid discharge system 100 according to the embodiment includes the liquid discharge head 10 that has the nozzle surface 1a and discharges the liquid, the head temperature adjuster 20 that adjusts a temperature of the liquid discharge head 10, the cap 40 that covers the nozzle surface 1a, the temperature sensor 61 that detects an indoor temperature, and the controller 500 that controls the head temperature adjuster 20 based on the indoor temperature detected by the temperature sensor 61 and the operation mode. The liquid discharge system 100 may include the controller 500 outside the liquid discharge apparatus 103.

The liquid discharge system 100 may include the liquid discharge head 10 that has the nozzle surface 1a and discharges the liquid, the head temperature adjuster 20 that adjusts a temperature of the liquid discharge head 10, the cap 40 that covers the nozzle surface 1a, the temperature sensor 61 that detects an indoor temperature, and the controller 500 that controls the head temperature adjuster 20 based on the indoor temperature detected by the temperature sensor 61 and the operation mode. The operation mode includes the liquid discharge mode for discharging the liquid from the liquid discharge head 10 and the moisturizing mode for covering the nozzle surface 1a with the cap 40 for moisturizing.

### Liquid Discharge Method

A liquid discharge method according to the embodiment includes a liquid discharge step of allowing the liquid discharge head 10 having the nozzle surface 1a to discharge a liquid, a step of covering the nozzle surface 1a with the cap 40 in a state where the liquid discharge head 10 does not discharge the liquid, a temperature detection step of detecting an indoor temperature, and a temperature adjustment step of adjusting a temperature of the liquid discharge head 10 based on the indoor temperature detected at the temperature detection step.

The liquid discharge method may include a liquid discharge step of allowing the liquid discharge head 10 having the nozzle surface 1a to discharge the liquid, a step of covering the nozzle surface 1a with the cap 40 in a state where the liquid discharge head 10 does not discharge the liquid, a temperature detection step of detecting an indoor temperature, and a temperature adjustment step of adjusting a temperature of the liquid discharge head 10 based on the indoor temperature detected at the temperature detection step and the operation mode. The operation mode includes the liquid discharge mode for discharging the liquid from the liquid discharge head 10 and the moisturizing mode for covering the nozzle surface 1a with the cap 40 for moisturizing.

### Program

A program according to the embodiment is a program for causing a computer to execute control processing of executing the liquid discharge step of allowing the liquid discharge head 10 having the nozzle surface 1a to discharge the liquid, and causes the computer to execute processing of executing the step of covering the nozzle surface 1a with the cap 40 in a state where the liquid discharge head 10 does not discharge the liquid, processing of executing the temperature detection step of detecting an indoor temperature, and processing of executing the temperature adjustment step of adjusting a temperature of the liquid discharge head 10 based on the indoor temperature detected at the temperature detection step.

The program may be a program for causing a computer to execute control processing of executing the liquid discharge step of allowing the liquid discharge head 10 having the nozzle surface 1a to discharge the liquid, and may cause the computer to execute processing of executing the step of covering the nozzle surface 1a with the cap 40 in a state where the liquid discharge head 10 does not discharge the liquid, processing of executing the temperature detection step of detecting an indoor temperature, and processing of executing the temperature adjustment step of adjusting the temperature of the liquid discharge head 10 based on the indoor temperature detected at the temperature detection step and the operation mode. The operation mode includes the liquid discharge mode for discharging the liquid from the liquid discharge head 10 and the moisturizing mode for covering the nozzle surface 1a with the cap 40 for moisturizing.

### Liquid Discharge Head According to First Modification Example

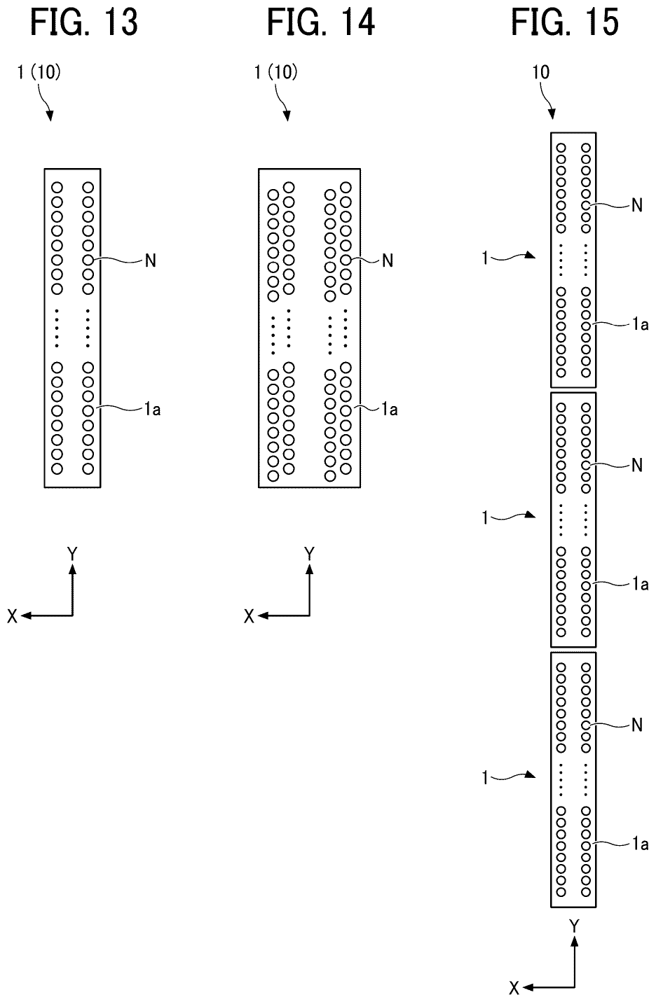

FIG. 13 is a bottom view illustrating the nozzle plate 1 of the liquid discharge head 10 according to a first modification example. A plurality of nozzle arrays is formed on the nozzle surface 1a of the 10 according to the first modification example. The nozzle arrays each include the plurality of nozzles N arrayed in the Y-axis direction. The plurality of nozzle arrays is disposed away from each other in an X-axis direction. The liquid discharge head 10 may include the nozzle plate 1 illustrated in FIG. 13.

### Liquid Discharge Head According to Second Modification Example

FIG. 14 is a bottom view illustrating the nozzle plate 1 of the liquid discharge head 10 according to a second modification example. For example, four nozzle arrays are formed on the nozzle plate 1 of the liquid discharge head according to the second modification example. In the plurality of nozzle arrays adjacent to each other in the X-axis direction, the nozzles N may be disposed in a shifted manner in the Y-axis direction.

### Liquid Discharge Head According to Third Modification Example

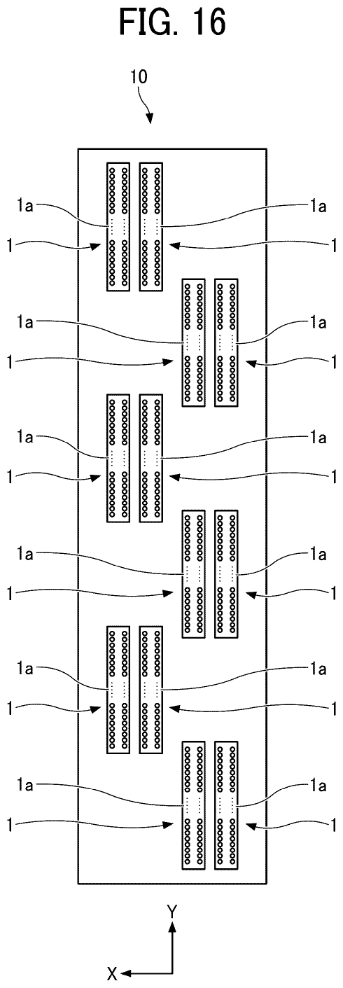

FIG. 15 is a bottom view illustrating the nozzle plates 1 of the liquid discharge heads 10 according to a third modification example. The liquid discharge head 10 according to the third modification example includes a plurality of the nozzle plates 1. The plurality of nozzle plates 1 is arrayed in the Y-axis direction.

### Liquid Discharge Head According to Fourth Modification Example

FIG. 16 is a bottom view illustrating the nozzle plates 1 of the liquid discharge heads 10 according to a fourth modification example. The liquid discharge head 10 according to the fourth modification example includes pairs of the nozzle plates 1, each two of which are adjacent to each other in the X-axis direction.

The plurality of nozzle plates 1 may be disposed away from each other in the Y-axis direction. The plurality of nozzle plates 1 may be disposed in a shifted manner in the Y-axis direction. The plurality of nozzle plates 1 may be disposed in a staggered manner. The pairs of nozzle plates 1, each two of which are adjacent to each other in the X-axis direction, may be disposed in a shifted manner in the Y-axis direction.

The embodiment described above has been presented as an example, and there is no intention of limiting the scope of the present embodiment. It is possible to implement the embodiment in various other forms, and it is possible to make various omissions, substitutions, and changes without departing from the gist of the present embodiment. The embodiment and the modification examples of the embodiment are included within the scope and gist of the present embodiment, and are also included within the present embodiment described in the claims and the equivalent scope.

In the present specification, image formation, printing, and character printing or recording are synonymous to each other.

### Processing Circuit

It is possible to implement each of the functions of the embodiment described above such as the controller 500 by one processing circuit or a plurality of processing circuits. The phrase “processing circuit” referred in the present specification includes a processor programmed to execute each of the functions by using software, similar to a processor implemented by an electronic circuit, and a device such as an application specific integrated circuit (ASIC), a digital signal processor (DSP), a field programmable gate array (FPGA), or a conventional circuit module designed to execute each of the functions described above, for example. The processing circuit may be referred to simply as “circuitry”.

In the embodiment described above, the liquid discharge apparatus 103 including the liquid discharge head 10 serving as a line head has been described. However, the liquid discharge head 10 is not limited to the line head. The liquid discharge apparatus 103 may include a carriage on which the liquid discharge head 10 is mounted. The liquid discharge apparatus 103 may include a serial type liquid discharge head 10.

A recording medium P may be plain paper, glossy paper, or a film, for example.

The liquid to be discharged from the liquid discharge head 10 is not limited to an ink. The liquid may be a solvent such as water or an organic solvent. The liquid may be a liquid containing a colorant such as a dye or a pigment. The liquid may be, for example, a liquid containing a functionality-imparting material such as a polymerizable compound, a resin, or a surfactant. The liquid may be, for example, a liquid containing a biocompatible material such as deoxyribonucleic acid (DNA), amino acid, protein, or calcium. The liquid may be a liquid containing an edible material such as a natural pigment. The liquid may be a suspension or an emulsion, for example.

The liquid may be, for example, an inkjet ink or a surface treatment liquid. The liquid may be a forming liquid for forming components of an electronic element or a light emitting element. The liquid may be a liquid for forming an electronic circuit resist pattern. The liquid may be a material liquid for three-dimensional modeling.

According to the present embodiment, it is possible to provide a liquid discharge apparatus that can suppress drying of a liquid in a state where the liquid is not to be discharged and of suppressing adhesion of dew condensation onto a nozzle surface in a state where the liquid is to be discharged.

Example aspects of the present embodiment may be as follows.

### Aspect 1

According to Aspect 1, a liquid discharge apparatus includes: a liquid discharge head that has a nozzle surface and discharges a liquid; a head temperature adjuster that adjusts a temperature of the liquid discharge head; a temperature sensor that detects an indoor temperature or a temperature around the nozzle surface; and a controller that controls the head temperature adjuster based on the temperature detected by the temperature sensor.

### Aspect 2

According to Aspect 2, in the liquid discharge apparatus of Aspect 1, the controller causes the head temperature adjuster to stop temperature adjustment when the liquid discharge head does not execute discharge operation for a certain period of time.

### Aspect 3

According to Aspect 3, the liquid discharge apparatus of Aspect 1 or Aspect 2 further includes a cap that covers the nozzle surface, the cap being filled with a wetting liquid in a state where the nozzle surface is covered with the cap.

### Aspect 4

According to Aspect 4, the liquid discharge apparatus of any one of Aspect 1 to Aspect 3 further includes a plurality of the liquid discharge heads; and a cap that covers the nozzle surface, the cap covering a plurality of the nozzle surfaces of the plurality of liquid discharge heads.

### Aspect 5

According to Aspect 5, a liquid discharge apparatus includes: a liquid discharge head that has a nozzle surface and discharges a liquid; a head temperature adjuster that adjusts a temperature of the liquid discharge head; a cap that covers the nozzle surface; a temperature sensor that detects an indoor temperature or a temperature around the nozzle surface; and a controller that controls the head temperature adjuster based on the temperature detected by the temperature sensor and an operation mode, the operation mode including: a liquid discharge mode for discharging the liquid from the liquid discharge head; and a moisturizing mode for covering the nozzle surface with the cap for moisturizing.

### Aspect 6

According to Aspect 6, the liquid discharge apparatus of Aspect 5 further includes a medium conveyor that conveys a recording medium, in which the controller controls the head temperature adjuster based on a type of the recording medium.

### Aspect 7

According to Aspect 7, in the liquid discharge apparatus of Aspect 5 or Aspect 6, the controller controls, when a thickness of the recording medium corresponds to a second thickness that is thicker than a first thickness, the head temperature adjuster to allow the temperature of the liquid discharge head to be a high temperature, compared with a case when the thickness of the recording medium corresponds to the first thickness.

### Aspect 8

According to Aspect 8, the liquid discharge apparatus of any one of Aspect 5 to Aspect 7 further includes a humidity sensor that detects humidity around the liquid discharge head, in which the controller controls, when the humidity corresponds to second humidity that is higher than first humidity, the head temperature adjuster to allow the temperature of the liquid discharge head to be a high temperature, compared with a case when the humidity corresponds to the first humidity.

### Aspect 9

According to Aspect 9, the liquid discharge apparatus of any one of Aspect 5 to Aspect 8 further includes a medium conveyor that conveys a recording medium, in which the controller controls, when a conveyance speed for the recording medium corresponds to a second speed that is higher than a first speed, the head temperature adjuster to allow the temperature of the liquid discharge head to be a high temperature, compared with a case when the conveyance speed corresponds to the first speed.

### Aspect 10

According to Aspect 10, the liquid discharge apparatus of any one of Aspect 5 to Aspect 9 further includes a dryer that dries the recording medium after the liquid has been discharged, in which the controller controls, when a set temperature to be attained by the dryer corresponds to a second temperature that is higher than a first temperature, the head temperature adjuster to allow the temperature of the liquid discharge head to be a high temperature, compared with a case when the set temperature to be attained by the dryer corresponds to the first temperature.

### Aspect 11

According to Aspect 11, the liquid discharge apparatus of any one of Aspect 5 to Aspect 10 further includes a medium conveyor that conveys roll paper serving as a recording medium, in which a longitudinal direction of the nozzle surface extends in a direction intersecting a conveyance direction of the recording medium.

### Aspect 12

According to Aspect 12, in the liquid discharge apparatus of any one of Aspect 5 to Aspect 11, the recording medium has a first surface and a second surface facing each other in a thickness direction, and the liquid discharge head discharges the liquid onto the first surface and the second surface.

### Aspect 13

According to Aspect 13, the liquid discharge apparatus of any one of Aspect 1 to Aspect 12 further includes a cap that covers the nozzle surface, in which, in a state where the liquid discharge head discharges the liquid and a state where the nozzle surface is covered with the cap, the controller controls the head temperature adjuster to allow the set temperatures of the liquid discharge head to be different from each other.

### Aspect 14

According to Aspect 14, in the liquid discharge apparatus of any one of Aspect 1 to Aspect 13, the controller controls, when the temperature sensor has detected a high temperature, the head temperature adjuster to allow the temperature of the liquid discharge head to be a high temperature, compared with a case when the temperature sensor has detected a low temperature.

### Aspect 15

According to Aspect 15, in the liquid discharge apparatus of any one of Aspect 1 to Aspect 14, the head temperature adjuster has a circulation channel in which a fluid for temperature adjustment is allowed to circulate, and allows the fluid for temperature adjustment to circulate to adjust the temperature of the liquid discharge head.

### Aspect 16

According to Aspect 16, in the liquid discharge apparatus of any one of Aspect 1 to Aspect 15, the liquid is an aqueous pigment ink.

### Aspect 17

According to Aspect 17, an image forming apparatus includes: a liquid discharge head that has a nozzle surface and discharges a liquid; a head temperature adjuster that adjusts a temperature of the liquid discharge head; a cap that covers the nozzle surface; a temperature sensor that detects an indoor temperature or a temperature around the nozzle surface; and a controller that controls the head temperature adjuster based on the temperature detected by the temperature sensor.

### Aspect 18

According to Aspect 18, an image forming apparatus includes: a liquid discharge head that has a nozzle surface and discharges a liquid; a head temperature adjuster that adjusts a temperature of the liquid discharge head; a cap that covers the nozzle surface; a temperature sensor that detects an indoor temperature or a temperature around the nozzle surface; and a controller that controls the head temperature adjuster based on the temperature detected by the temperature sensor and an operation mode, the operation mode including: a liquid discharge mode for discharging the liquid from the liquid discharge head; and a moisturizing mode for covering the nozzle surface with the cap for moisturizing.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

1. A liquid discharge apparatus comprising:
a head having a nozzle surface having nozzles to discharge a liquid;
a head temperature adjuster to adjust head temperature of the head;
a temperature sensor to detect:
an indoor temperature; or
a nozzle surface temperature around the nozzle surface; and
circuitry configured to control the head temperature adjuster to adjust the head temperature based on the indoor temperature or the nozzle surface temperature detected by the temperature sensor.

2. The liquid discharge apparatus according to claim 1,
wherein the circuitry controls the head temperature adjuster to stop adjusting the head temperature when the head has not discharged the liquid for a certain period.

3. The liquid discharge apparatus according to claim 1, further comprising a cap filled with a wetting liquid to cover the nozzle surface.

4. The liquid discharge apparatus according to claim 1, further comprising:
a plurality of heads including the head, each of the plurality of heads having the nozzle surface; and
a cap to cover the nozzle surface of each of the plurality of heads.

5. A liquid discharge apparatus comprising:
a head having a nozzle surface having nozzles to discharge a liquid onto a medium;
a head temperature adjuster to adjust a head temperature of the head;
a cap to cover the nozzle surface;
a temperature sensor to detect:
an indoor temperature; or a nozzle surface temperature around the nozzle surface; and
circuitry configured to control the head temperature adjuster to adjust the head temperature based on:
the indoor temperature or the nozzle surface temperature detected by the temperature sensor; and
an operation mode including:
a liquid discharge mode to discharge the liquid from the head; and
a moisturizing mode to cover the nozzle surface with the cap to moisturize the nozzle surface.

6. The liquid discharge apparatus according to claim 5, further comprising:
a conveyor to convey the medium,
wherein the circuitry controls the head temperature adjuster to adjust the head temperature based on a type of the medium to be conveyed by the conveyor.

7. The liquid discharge apparatus according to claim 6,
wherein the circuitry controls the head temperature adjuster to adjust the head temperature to a first temperature when the medium has a first thickness, and
the circuitry controls the head temperature adjuster to adjust the head temperature to a second temperature higher than the first temperature when the medium has a second thickness thicker than the first thickness.

8. The liquid discharge apparatus according to claim 5, further comprising:
a humidity sensor to detect humidity in a vicinity of the head,
wherein the circuitry controls the head temperature adjuster to adjust the head temperature to a first temperature when the humidity detected by the humidity sensor is lower than a humidity threshold, and
the circuitry controls the head temperature adjuster to adjust the head temperature to a second temperature higher than the first temperature when the humidity detected by the humidity sensor is higher than the humidity threshold.

9. The liquid discharge apparatus according to claim 5, further comprising:
a conveyor to convey the medium at a first speed or a second speed faster than the first speed,
wherein the circuitry controls the head temperature adjuster to adjust the head temperature to a first temperature when the conveyor conveys the medium at the first speed, and
the circuitry controls the head temperature adjuster to adjust the head temperature to a second temperature higher than the first temperature when the conveyor conveys the medium at the second speed.

10. The liquid discharge apparatus according to claim 5, further comprising:
a dryer to dry the medium onto which the liquid has been discharged with a first drying temperature or a second drying temperature higher than the first drying temperature,
wherein the circuitry controls the head temperature adjuster to adjust the head temperature to a first temperature when the dryer is set to the first drying temperature, and
the circuitry controls the head temperature adjuster to adjust the head temperature to a second temperature higher than the first temperature when the dryer is set to the second drying temperature.

11. The liquid discharge apparatus according to claim 5, further comprising:
a conveyor to convey a roll paper in a conveyance direction,
wherein the nozzles on the nozzle surface are arrayed in a direction intersecting the conveyance direction.

12. The liquid discharge apparatus according to claim 5,
wherein the medium has a first surface and a second surface opposite to the first surface, and
the head discharges the liquid onto each of the first surface and the second surface.

13. The liquid discharge apparatus according to claim 1, further comprising
a cap to cover the nozzle surface,
wherein the circuitry controls the head temperature adjuster to adjust the head temperature to a first temperature when the head discharges the liquid, and
the circuitry controls the head temperature adjuster to adjust the head temperature to a second temperature different from the first temperature when the cap covers the nozzle surface.

14. The liquid discharge apparatus according to claim 1,
wherein the circuitry controls the head temperature adjuster to adjust the head temperature to a first temperature when the indoor temperature or the nozzle surface temperature detected by the temperature sensor is lower than a temperature threshold, and
the circuitry controls the head temperature adjuster to adjust the head temperature to a second temperature higher than the first temperature when the indoor temperature or the nozzle surface temperature detected by the temperature sensor is higher than the temperature threshold.

15. The liquid discharge apparatus according to claim 1,
wherein the head temperature adjuster includes a circulation channel to circulate a fluid through the circulation channel to adjust the head temperature.

16. The liquid discharge apparatus according to claim 1, wherein the liquid is an aqueous pigment ink.

17. An image forming apparatus comprising:
a head having a nozzle surface having nozzles to discharge a liquid;
a head temperature adjuster to adjust head temperature of the head;
a temperature sensor to detect:
an indoor temperature; or
a nozzle surface temperature around the nozzle surface; and
circuitry configured to control the head temperature adjuster to adjust the head temperature based on the indoor temperature or the nozzle surface temperature detected by the temperature sensor.

18. An image forming apparatus comprising:
a head having a nozzle surface having nozzles to discharge a liquid;
a head temperature adjuster to adjust a head temperature of the head;
a cap to cover the nozzle surface;
a temperature sensor to detect:
an indoor temperature; or
a nozzle surface temperature around the nozzle surface; and
circuitry configured to control the head temperature adjuster to adjust the head temperature based on:
the indoor temperature or the nozzle surface temperature detected by the temperature sensor; and
an operation mode including:
a liquid discharge mode to discharge the liquid from the head; and
a moisturizing mode to cover the nozzle surface with the cap to moisturize the nozzle surface.
